(19) United States
(12) Patent Application Publication
(10) Pub. No.: US 2005/0010639 A1
(43) Pub. Date: Jan. 13, 2005

(54) Network meeting system

(76) Inventors: James Long, Sunnyvale, CA (US); Felix Leung, Hong Kong (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/838,425

(22) Filed: May 3, 2004

Related U.S. Application Data
(60) Provisional application No. 60/467,739, filed on May 1, 2003.
(60) Provisional application No. 60/467,545, filed on May 1, 2003.

(51) Int. Cl. G06F 15/16

(52) U.S. Cl. 709/204; 709/232

(57) ABSTRACT

In one embodiment, the inventor provides a method, comprising automatically capturing a first screen shot of an active application; saving the first screen shot in a directory from which a server attempts to retrieve downloadable files for a network; automatically generating a code to create a web page, wherein the code contains a reference to the first screen shot; and publishing the web page.

This application claims priority to Provisional U.S. patent Application No. 60/467,739, filed May 1, 2003, entitled “Network Download System,” and Provisional U.S. patent Application No. 60/467,545, filed May 1, 2003, entitled “Network Meeting System,” both of which are hereby incorporated by reference.

### FIELD OF THE INVENTION

The present invention relates to network communications systems generally and particularly network meeting systems.

### BACKGROUND

Traditionally, in hosting a meeting over an interconnected network such as the Internet, a meeting host server advertises and promotes the meeting as to the subject matter of the meeting and the time and location of the meeting. Parties interested in participating in the meeting join the meeting via their network connections at the designated time.

The traditional paradigm of an on-line meeting, referring to FIG. 1A, consists of a host server 110 connecting a number of meeting participants 112a-112c through their respective individual connection means 114a-114c. This is a client/server paradigm where a host server connects a number of meeting participants or clients. Under this paradigm, a great deal of computing resources are consumed by the host server.

The traditional paradigm is no longer adequate in meeting the dynamic and flexible environment demanded by the activity of the interconnected network users of today and of the future. Ideally, given the level of activity on the Internet, a different paradigm, as is illustrated in FIG. 1B, is desirable. In this peer-to-peer paradigm, there is no host server, and a number of clients 118a-118e are connected via a number of connection means 120a-120e in a variety of manners. The advantage with this paradigm is that there is not a central host server to connect the clients. As long as the clients utilize application programs allowing communication across interconnected networks between the clients, this network paradigm is feasible and desirable.

Personal-servers are available on computers such as Windows PCs by installing server software, e.g. free Microsoft personal-server software: personal web-server pws10a.exe on Windows 95/98/Me or Internet Information Server (IIS) 3.0 or later on Windows 2000/NT/XP. When installed, the personal-server allows any meeting participant using a computer such as a Windows PC to have his/her own network server (e.g. web-site) when the computer is connected to an interconnected network (e.g. the Internet).

Establishing a point-to-point connection between any meeting participant and a personal-server (to download meeting content, e.g. HTML or XML web-pages) connected to an interconnected network generally requires that the URL (universal resource locator) address of the personal-server content be known to the connecting meeting participant.

Today's Internet use domain names and DNS (domain name server) lookups to allow Internet users to download content from web-sites or servers. A domain name is a name assigned to a fixed numeric IP Address, functioning as part of an URL (universal resource locator) address. For example, the domain name stanford.edu represents fixed numeric IP address 171.64.14.203. Domain names are used in URLs to identify particular content such as web-pages. In the URL http://www.stanford.edu/index.html, the domain name is stanford.edu. The DNS system matches a domain name to the correct fixed numeric IP address so that Internet users can visit a web-site (e.g. www.stanford.edu) without knowing its numeric IP address. A web-site then typically uses a default page index.html to form a default URL, e.g. http://www.stanford.edu/index.html, to allow content download when Internet users visit the site.

Many network communications service providers, such as Internet Service Providers (ISP's), assign connecting computers (and hence connecting personal-servers installed in the connecting computers) a different network address, such as an IP address, each time the connecting computers connect to the network, making foreknowledge of a particular personal-server's URL address impossible (for other meeting participants to download personal-server meeting contents). For computers and personal-servers having direct connections to the Internet through a company or organization, the IP addresses of the computers/personal-servers may be remapped, may change over time, or may be machine dependent. Furthermore, many companies and organizations have a computer network security barrier commonly referred to as a “firewall” to stop unauthorized intrusion into their computer networks, and the firewall may translate an IP address for a particular computer or personal-server such that the computer or personal-server is identified by a different IP address every time.

Some commercial and non-commercial services maintain network servers connected to a network. Meeting participants who connect to the network provide their current network address and other identifying information to these network servers. This information is made available to other meeting participants connected to the network for purposes including establishing a point-to-point communications. Such services include Internet Relay Chat (IRC), and Microsoft Meeting participant Location Service (ULS).

These services require that meeting participants actively seek out other meeting participants, often from among several hundreds or thousands of meeting participants known to a server to be connected to a network at any given time. Such services also do not enable a meeting participant to limit who may access that meeting participant's identification information.

In recent years, popular instant messaging services from Microsoft, AOL, ICQ, Yahoo!, etc. provide an improved communications system for facilitating locating a meeting participant who is connected to an interconnected network, for the purposes of establishing point-to-point communications. A meeting participant's location on an interconnected network is still expressed in terms of the meeting participant's current network address.

Unfortunately, one problem of the above-mentioned services is that if the central server(s) (e.g. for instant messaging service) goes down, all connected users lose their service.

In addition, a second problem associated with the above-mentioned services is that they do not generally provide for the unique identification of a URL address of meeting participant's personal-server meeting content. Thus, quick and accurate location of specific personal-server content (for downloading content relating to a meeting is difficult.

The third problem is the need for all meeting participants to (a) install the same browser helper application (i.e. plug-in software), or custom software (for all peer-to-peer and most client/server meetings), or (b) to join the meeting at the host server (for client/server paradigm).

The fourth problem is that IP (Internet protocol) phone audio can lose packets, which makes audio quality poor or unintelligible.

The fifth problem is that the number of connections in multipoint-to-multipoint peer-to-peer video meeting is an exponential function of participants, which become too complex for most video meeting system to handle for more than a few participants.

### BRIEF DESCRIPTION OF THE DRAWINGS

FIG. 1A illustrates connections in accordance with the client/server paradigm where meeting participants are connected to a central host server for the purpose of network meeting.

FIG. 1B illustrates connections in accordance with the peer-to-peer paradigm where meeting participants are connected to each other without a central host server.

FIG. 2A is a simplified pictorial illustration of a network meeting system constructed and operative in accordance with an embodiment of the present invention, wherein a meeting participant “A” is connecting to an interconnected network 14 via a computer “K” and meeting participant information is provided to a database-server 20 connected to the interconnected network 14.

FIG. 2B is a simplified pictorial illustration of a network meeting system constructed and operative in accordance with a preferred embodiment of the present invention, wherein a sought (meeting content) download “X” is connecting to the interconnected network 14 of FIG. 2A, information identifying the sought (meeting content) download “X” is provided to the database-server 20 of FIG. 2A, and wherein the database-server 20 of FIG. 2A reports information identifying the seeking meeting participant “A” to the sought (meeting content) download “X” of FIG. 2A (which database-server 20 in turn reports information identifying the sought (meeting content) download “X” to the seeking meeting participant “A”).

FIG. 3A is a simplified pictorial illustration of a network meeting system constructed and operative in accordance with an embodiment of the present invention, wherein the meeting participant “A” of FIG. 2A downloads the sought (meeting content) download “X” of FIG. 2B, having received the network URL address of sought (meeting content) download “X”.

FIG. 3B is a simplified pictorial illustration of a network meeting system constructed and operative in accordance with an embodiment of the present invention, is continuation of FIG. 3A, and illustrates a two-way (meeting content) download, wherein the meeting participant “A” of FIG. 3A specifies a 2-way-auto-download (FIG. 7A) so that computer “L” (used by participant “B”) will promptly call-back personal-server “T” (used by participant “A”) to auto-download the (meeting content) download “T”, after computer “L” (used by participant “B”) receives the URL address of (meeting content) download “T”.

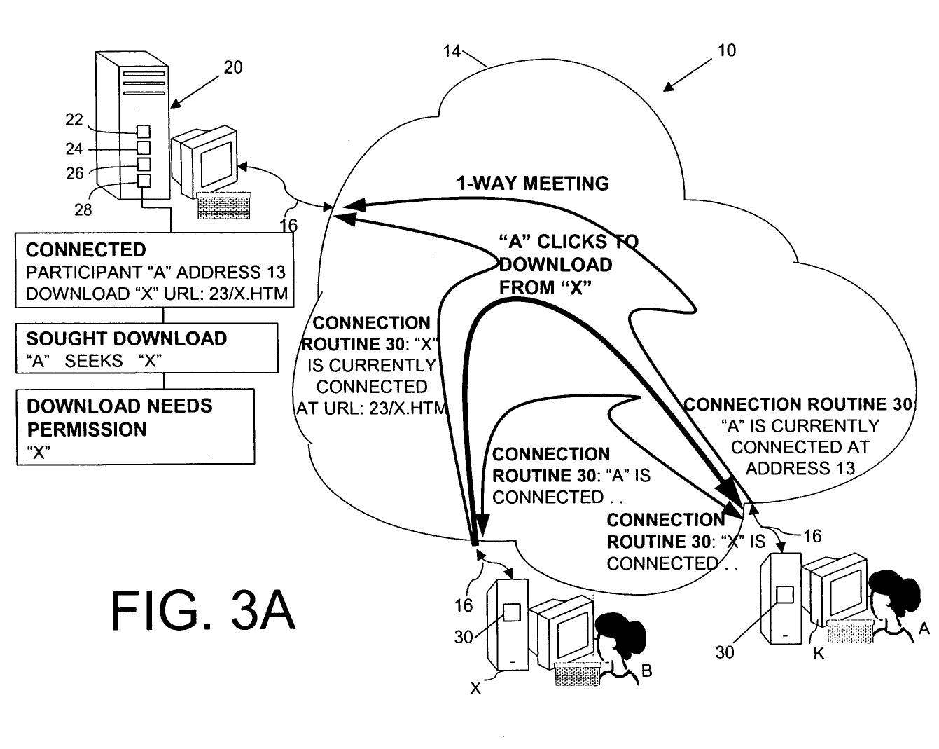

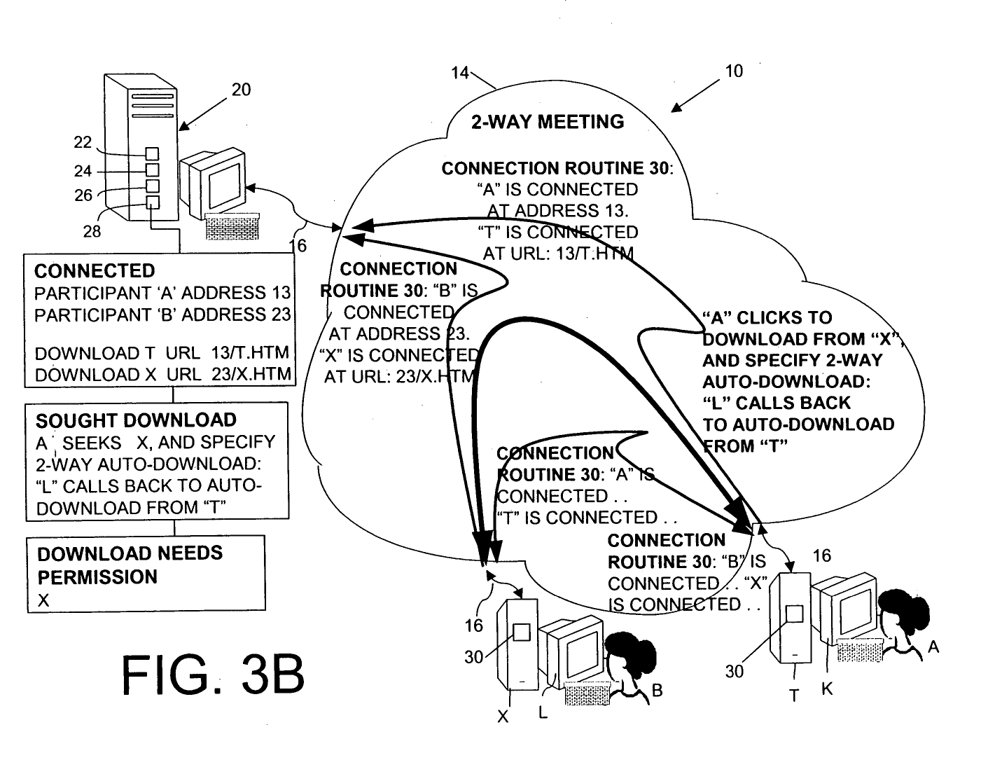

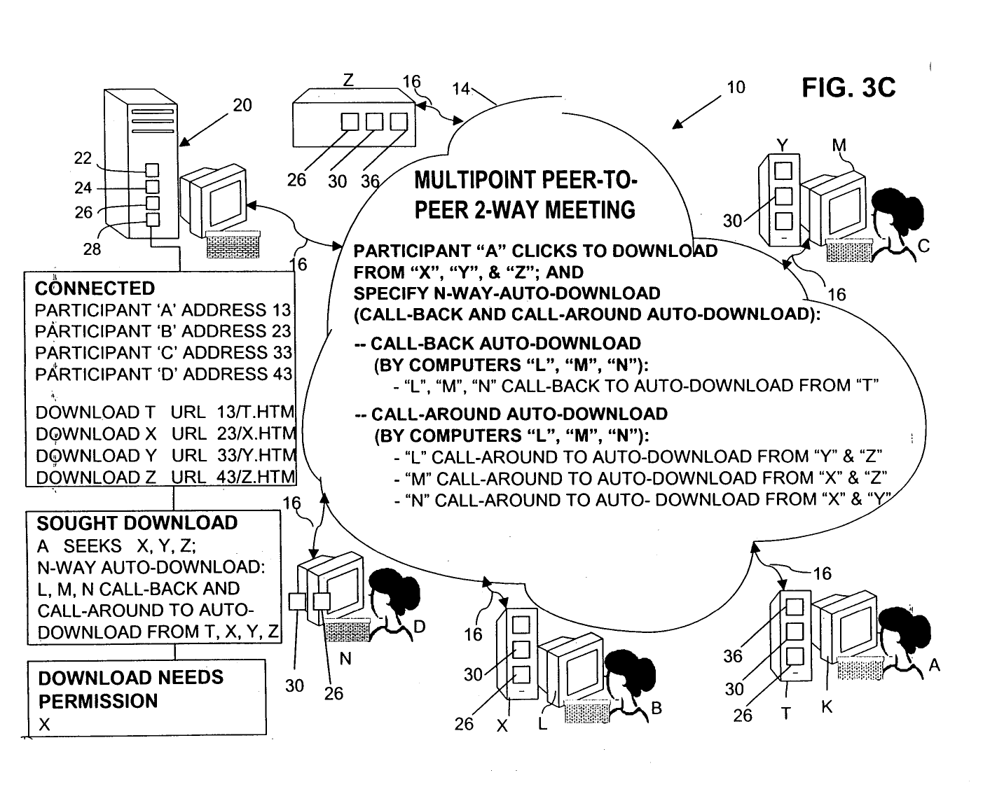

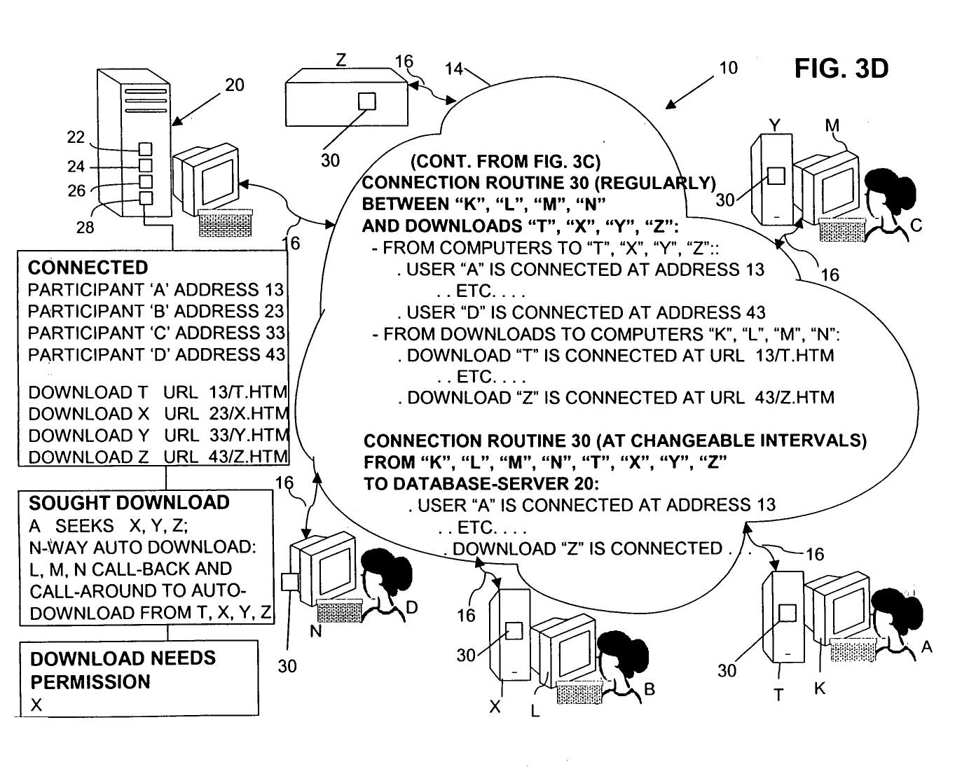

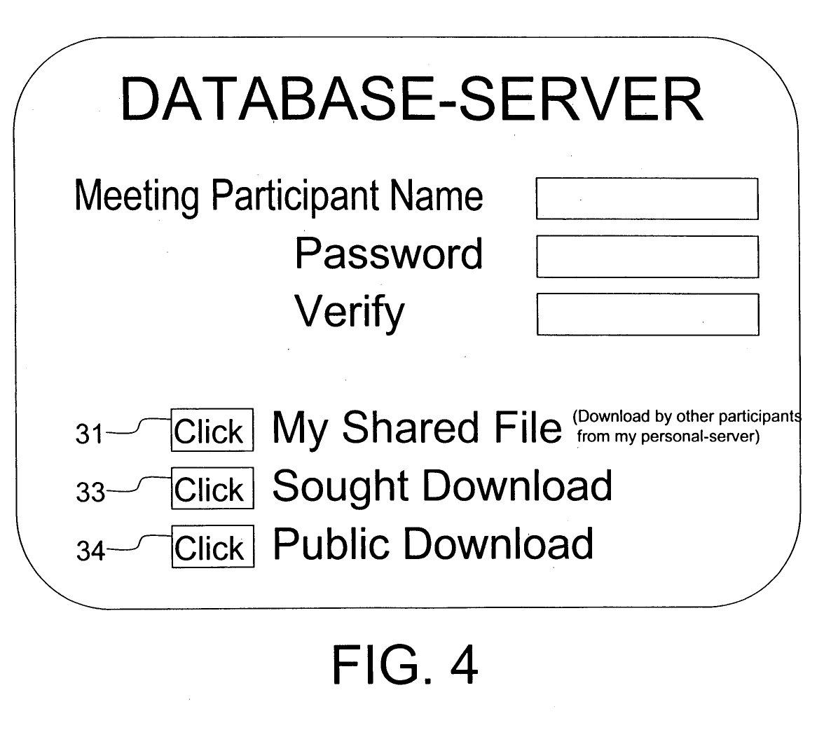

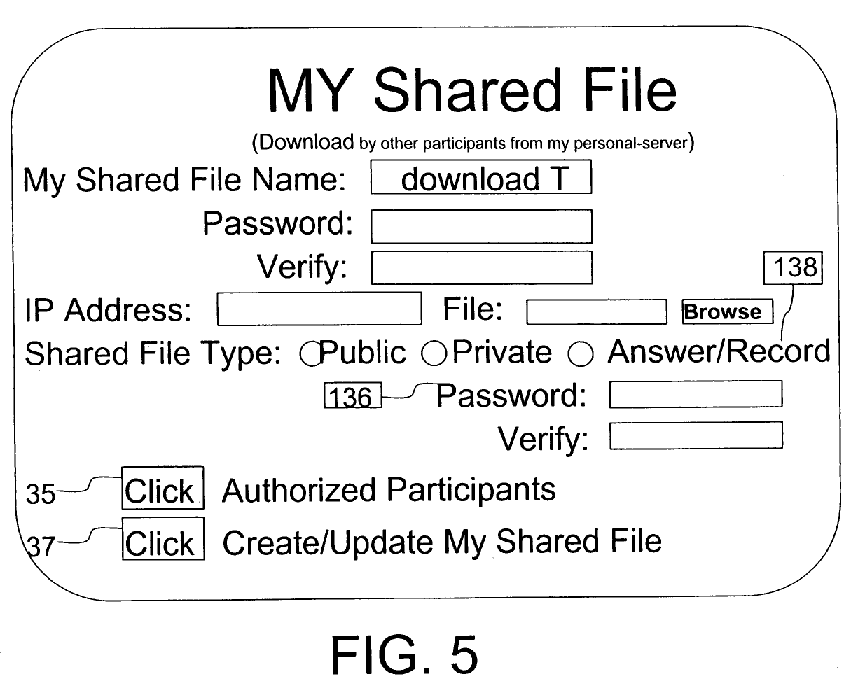

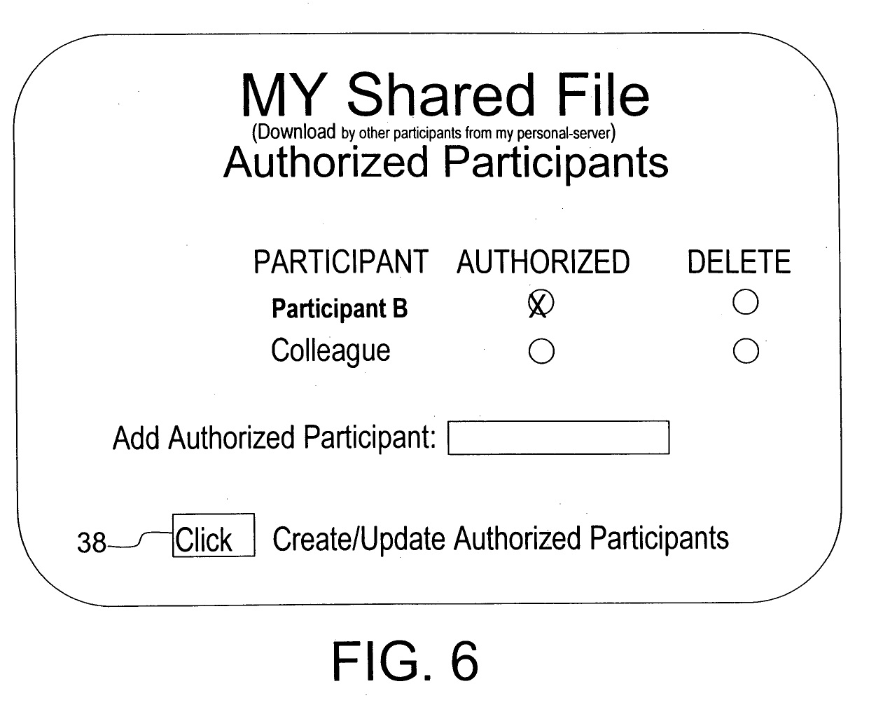

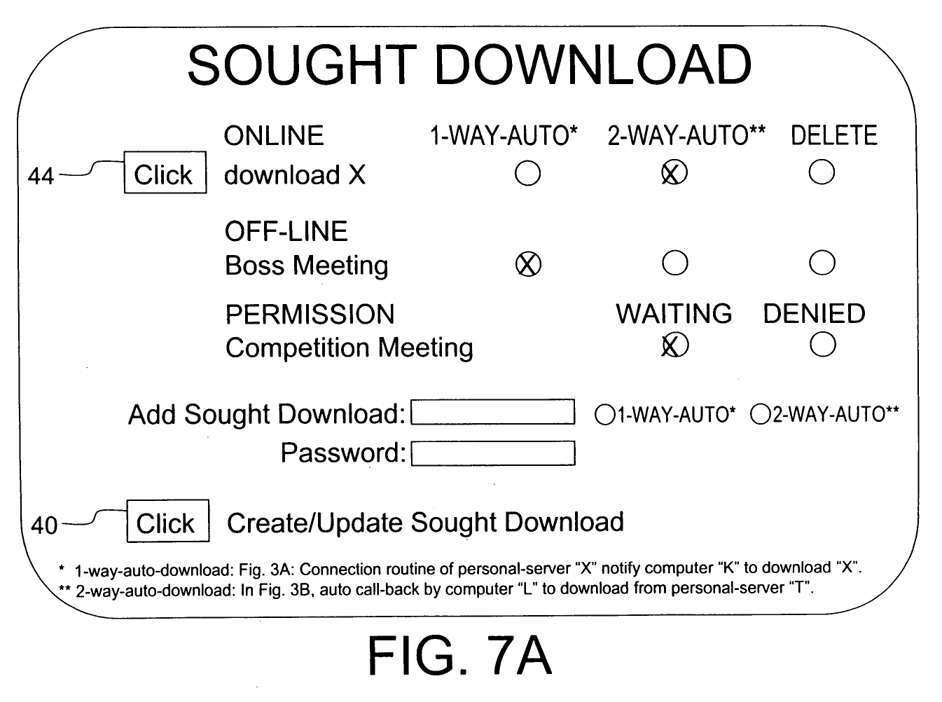

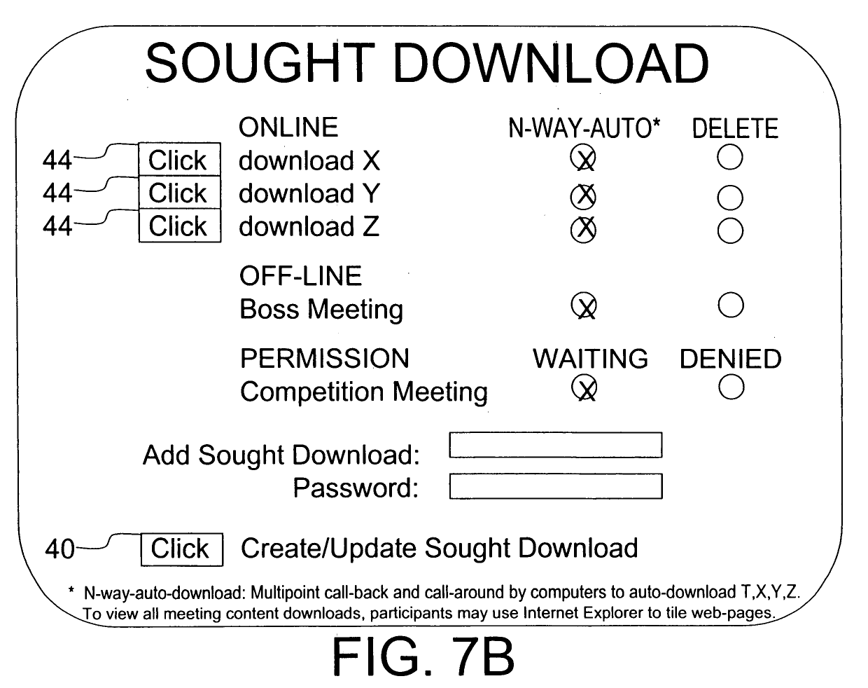

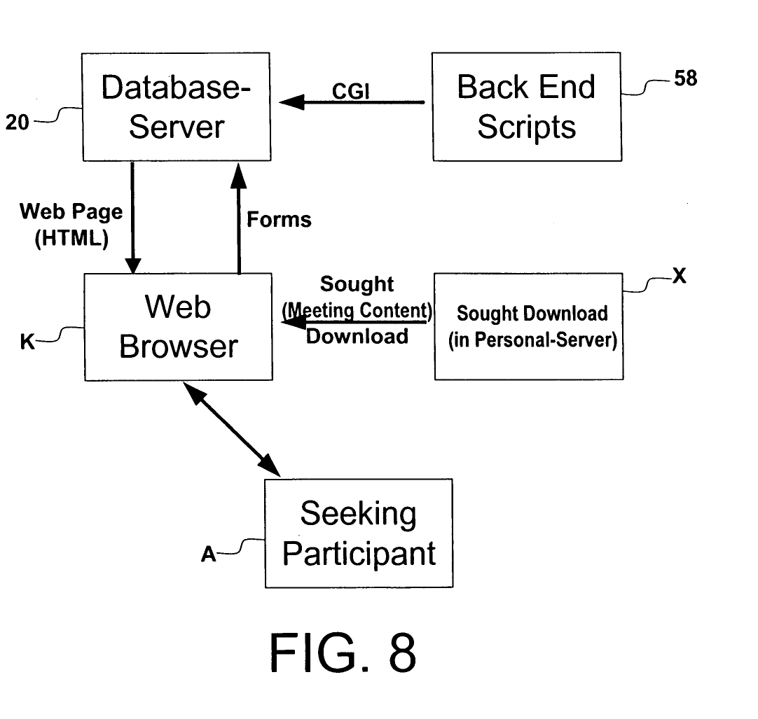

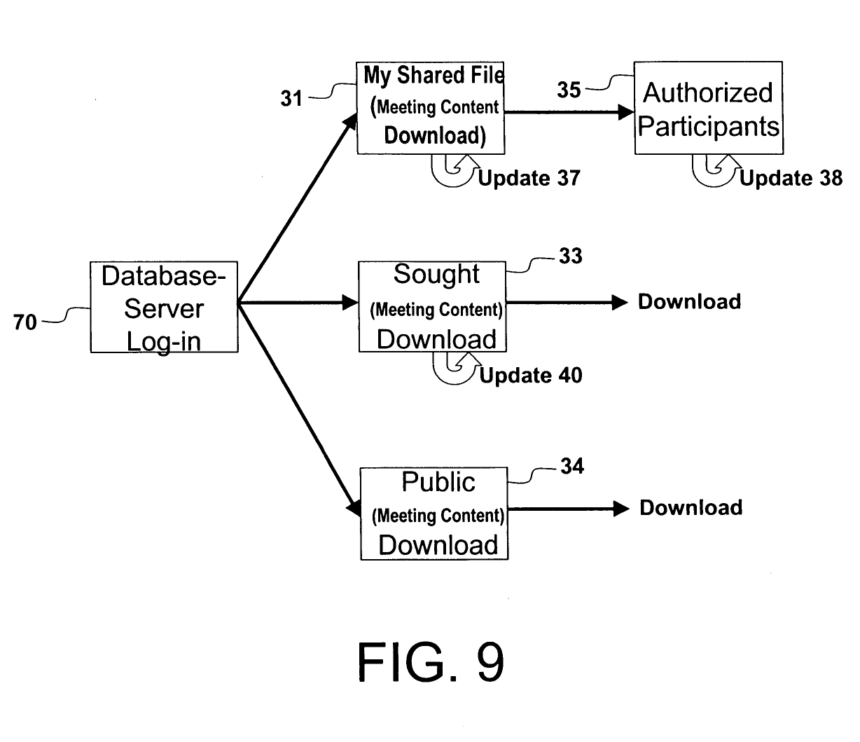

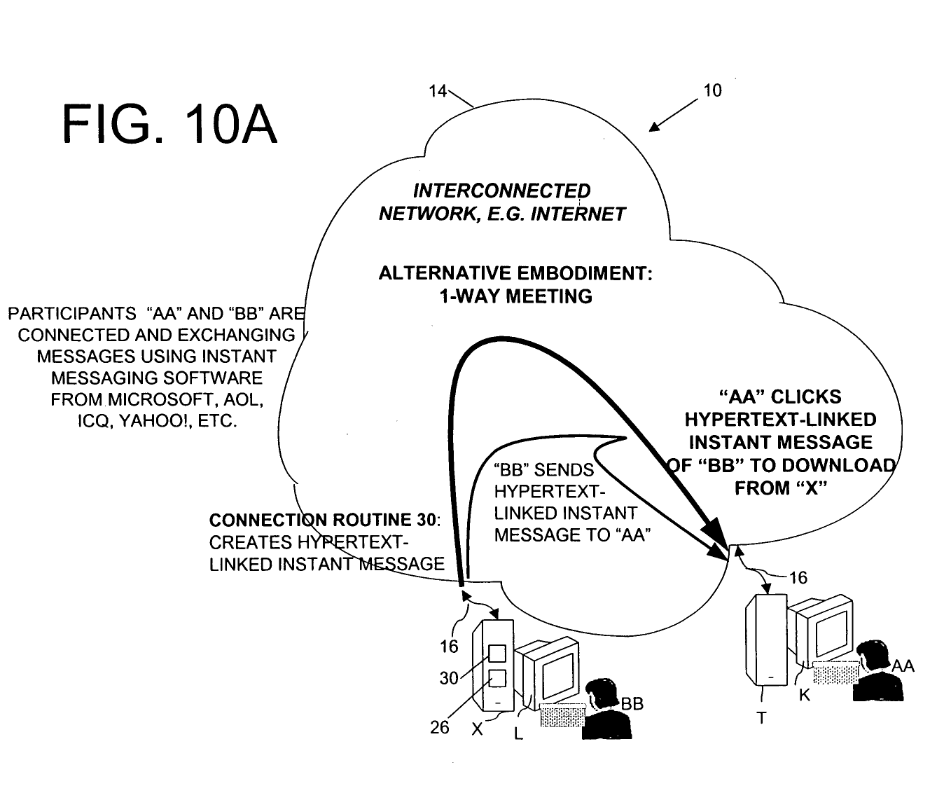

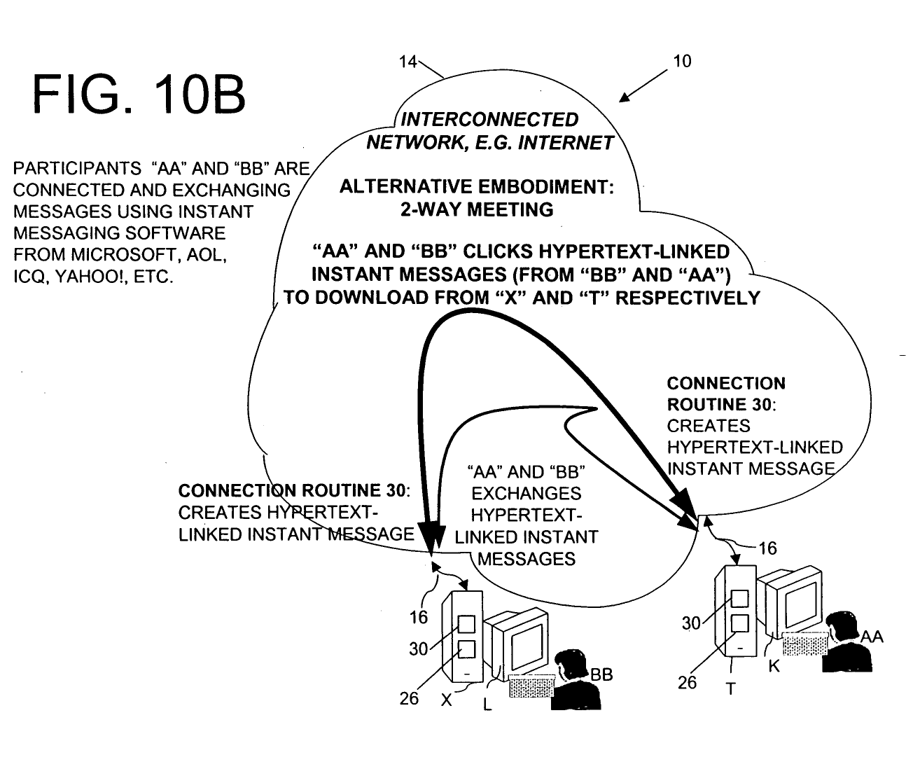

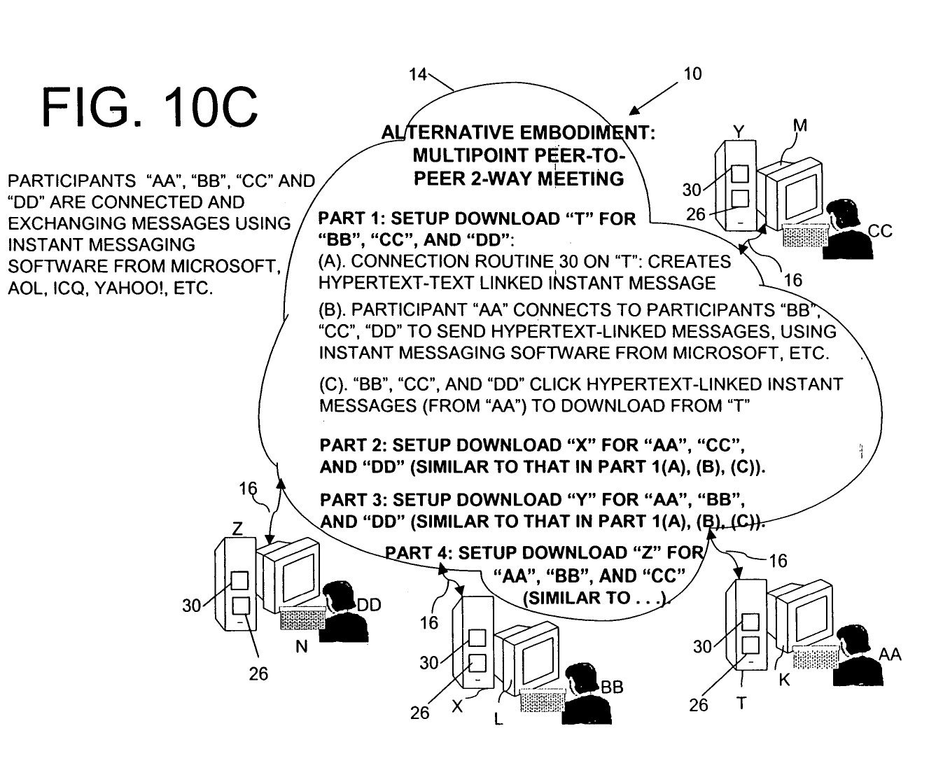

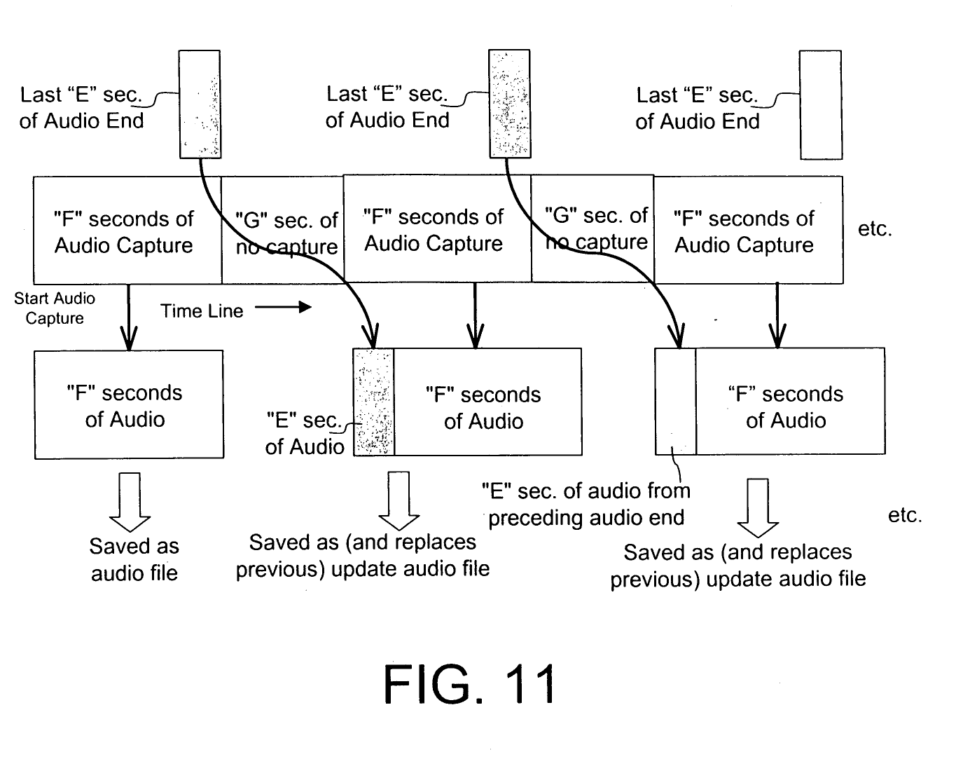

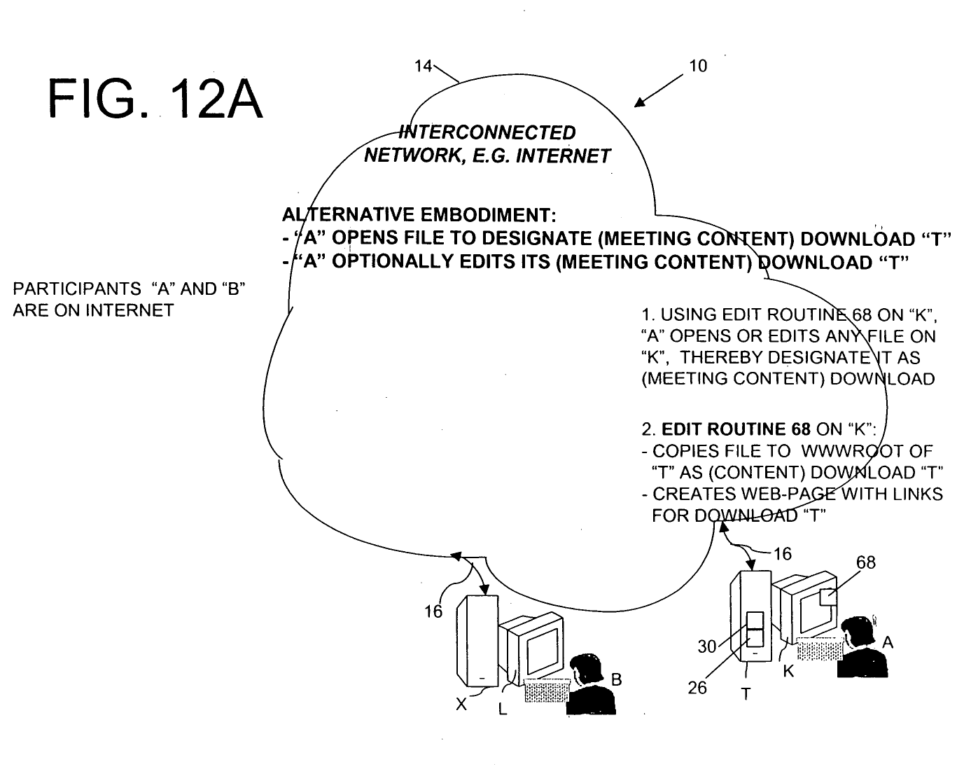

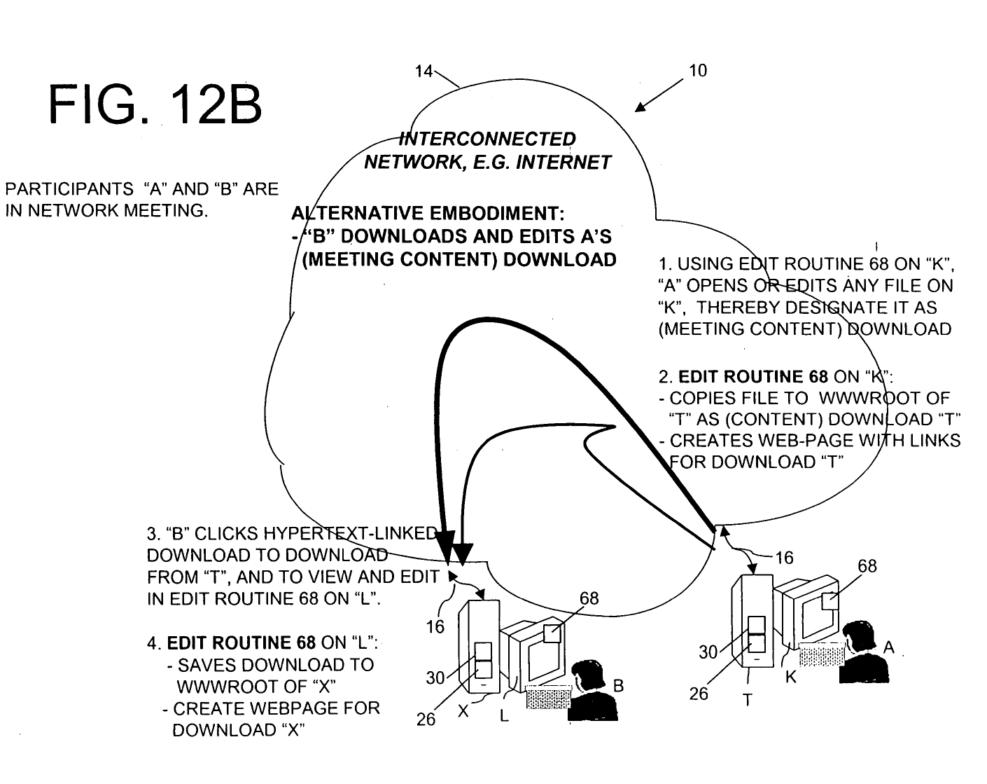

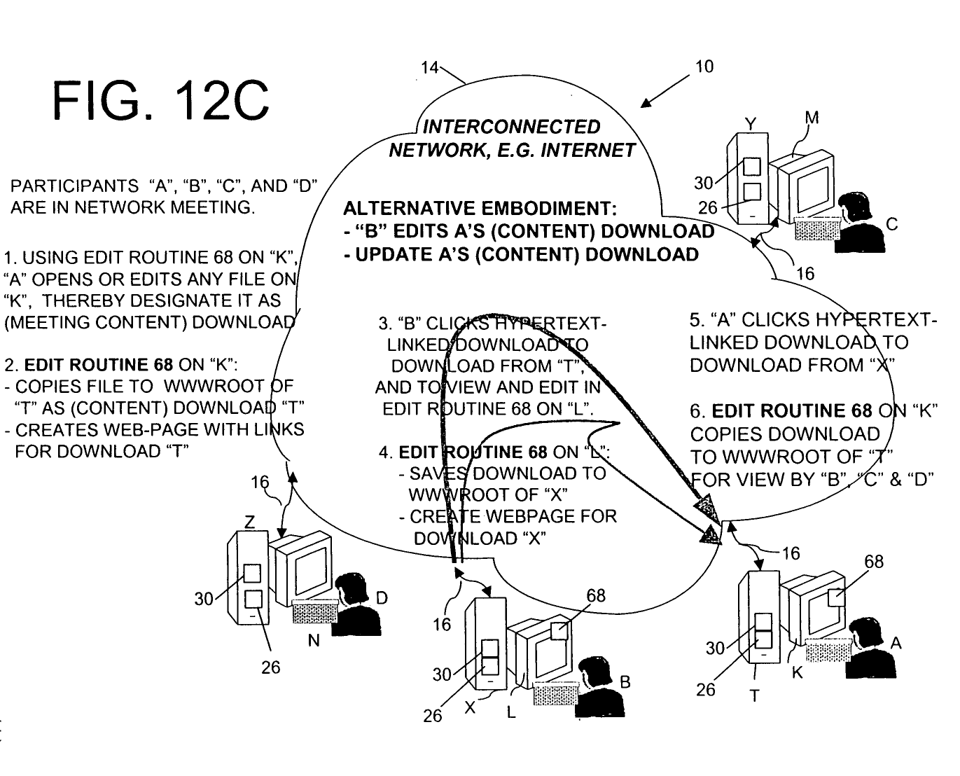

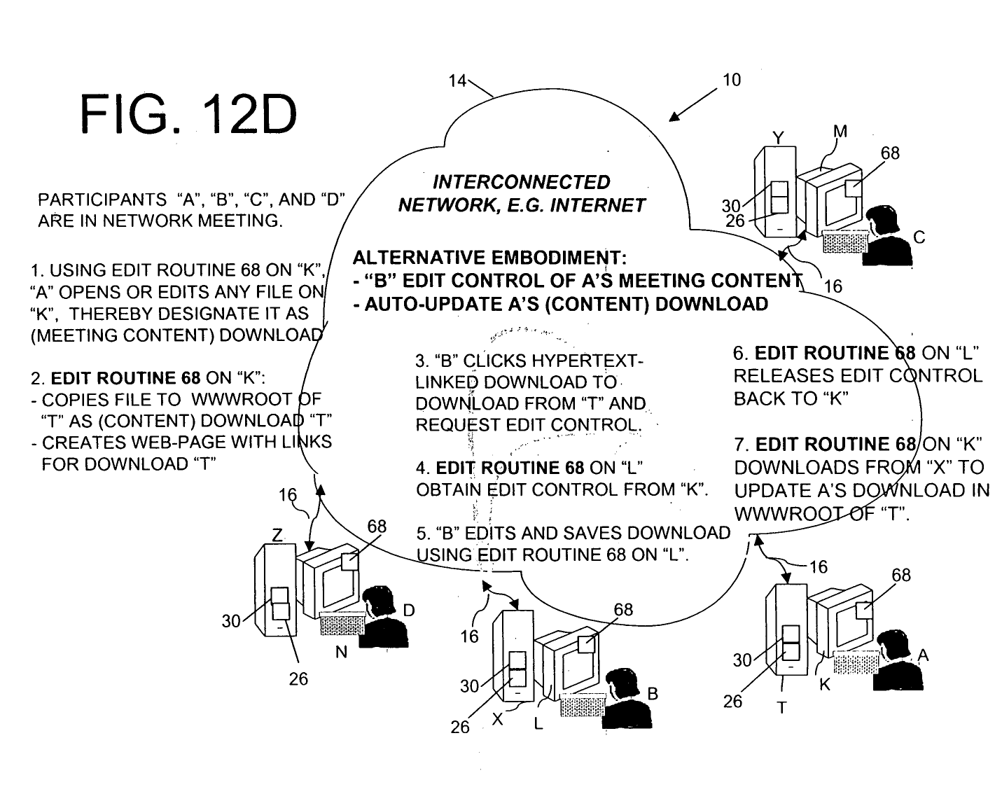

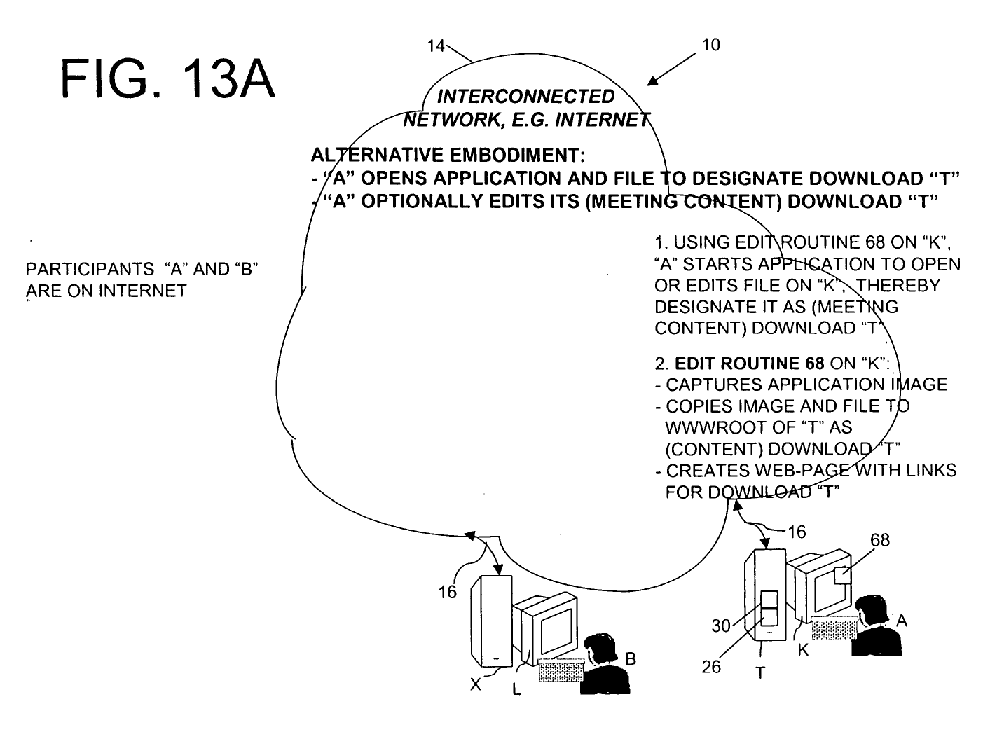

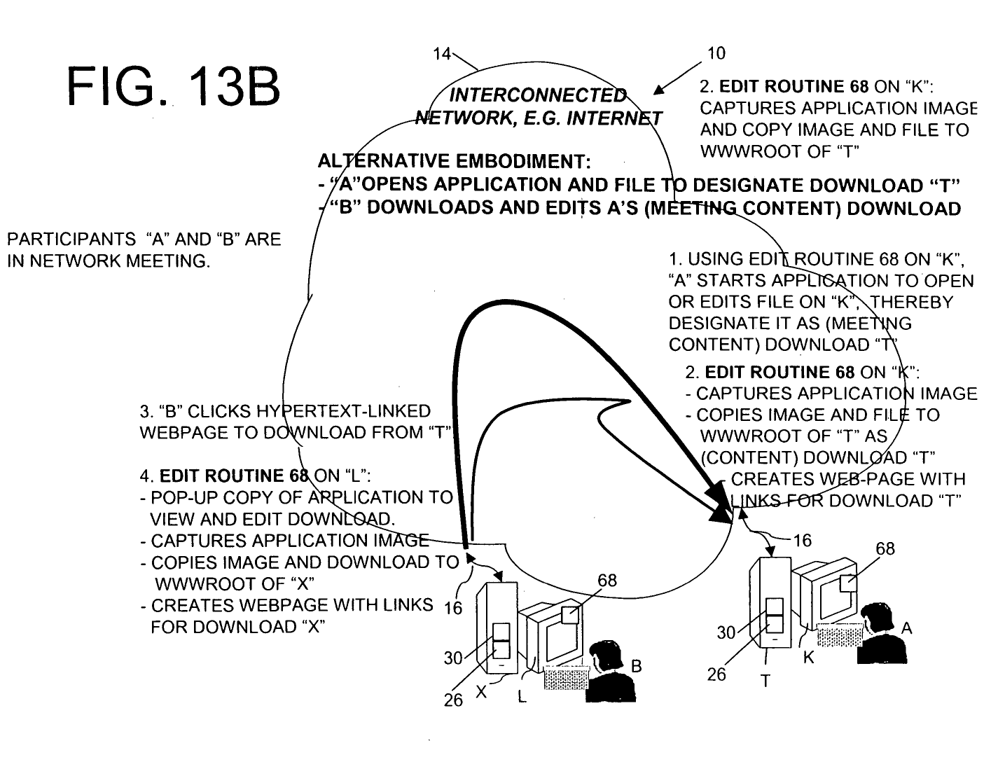

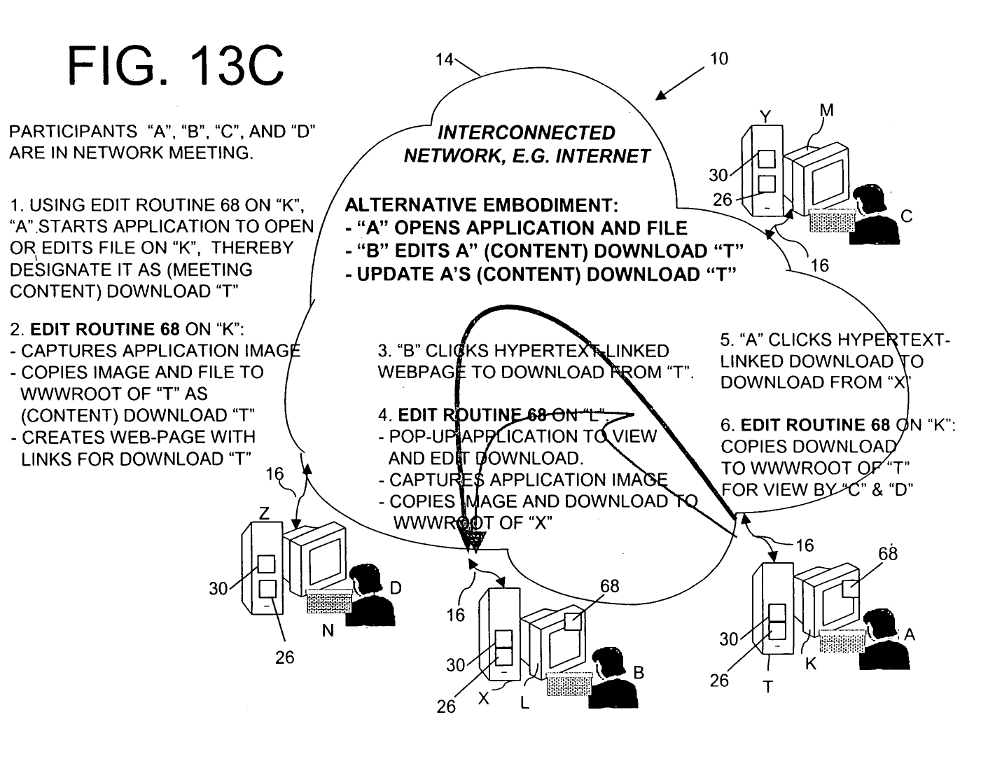

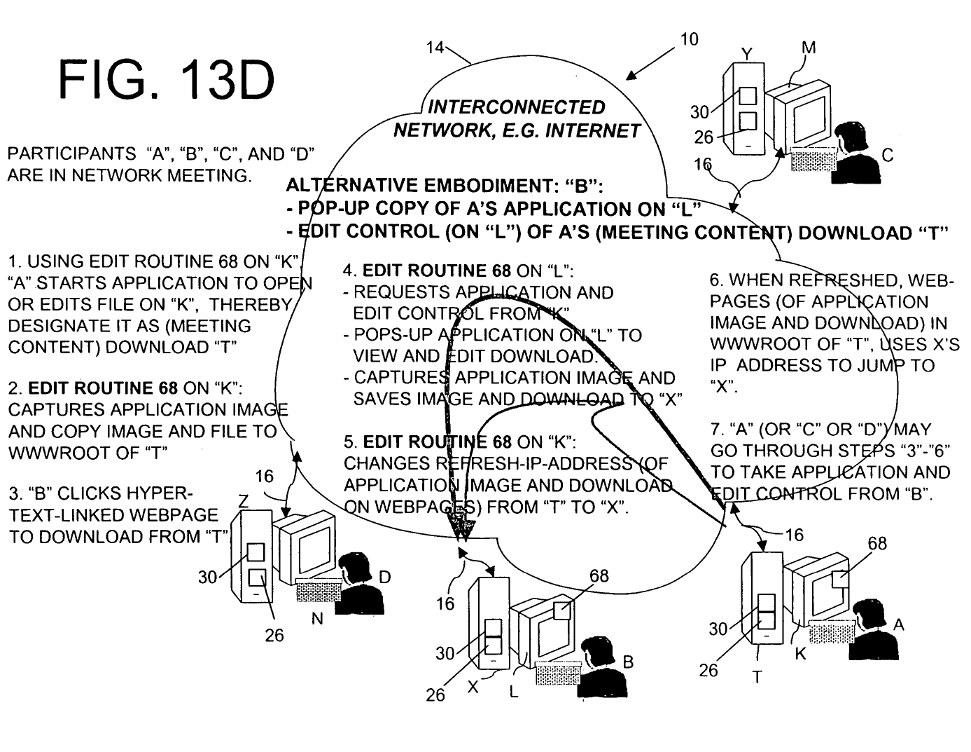

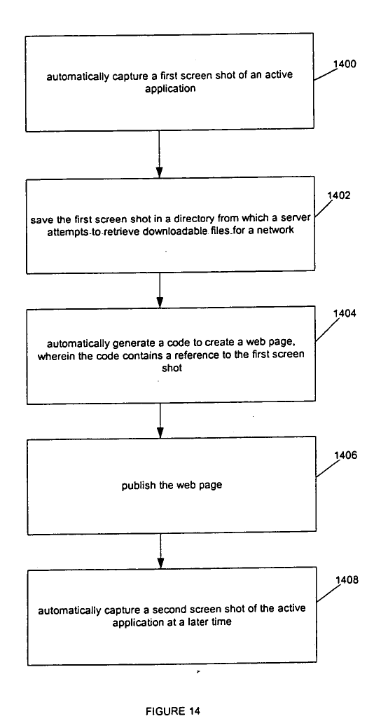

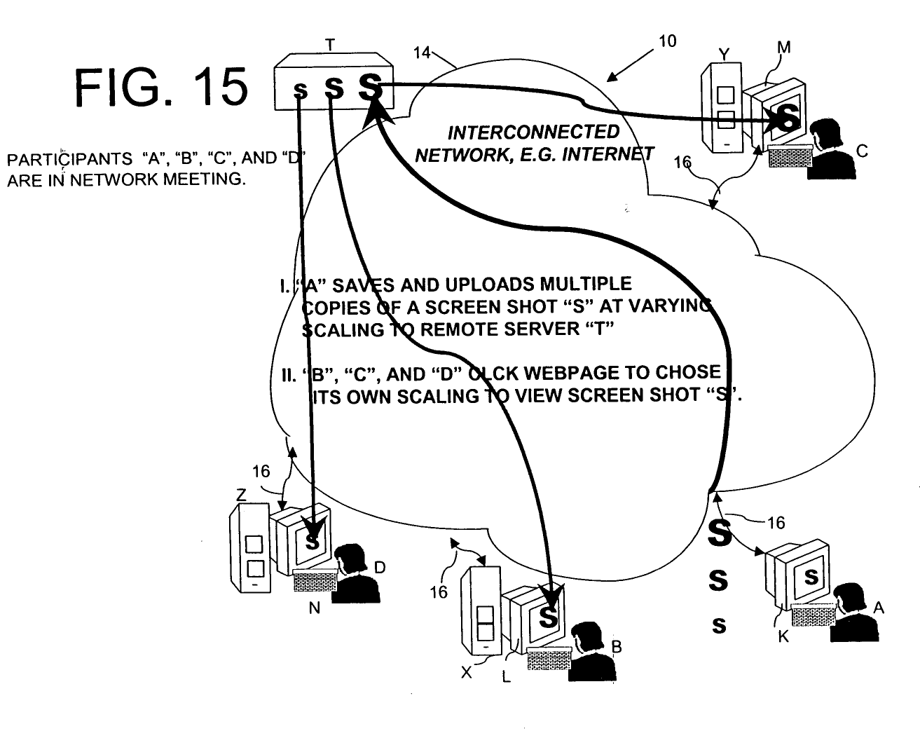

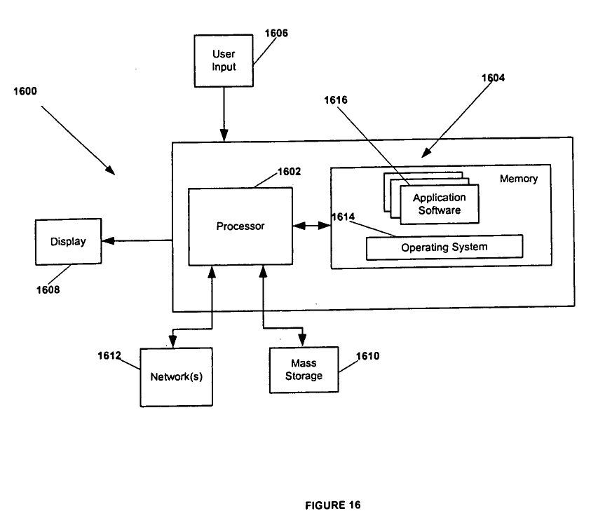

FIG. 3C is a simplified pictorial illustration of a network meeting system constructed and operative in accordance with an embodiment of the present invention, is continuation of FIG. 3B, and illustrates multipoint peer-to-peer two-way (meeting content) download, wherein the meeting participant “A” of FIG. 3A specifies an N-way-auto-download (FIG. 7B) so that the following happens:
a) call-back auto-download: computers “L”, “M”, “N” (used by participants “B”, “C”, “D” respectively) will promptly call-back personal-server “T” (used by participant “A”) to auto-download the (meeting content) download “T”, after computers “L”, “M”, “N” receive the URL address of (meeting content) download “T” (from connection routine 30 of computer “K” used by “A”).
b) call-around auto-download (by computers “L”, “M”, “N”):
   i) Computer “L” call-around to download from “Y” and “Z”, after computer “L” receives the URL addresses of downloads “Y” and “Z” (from connection routine 30 of computer “K” used by “A”);
   ii) Computer “M” call-around to download from “X” and “Z”, after computer “M” receives the URL addresses of downloads “X” and “Z” (from connection routine 30 of computer “K” used by
   iii) Computer “N” call-around to download from “Y” and “Z”, after computer “N” receives the URL addresses of downloads “X” and “Y” (from connection routine 30 of computer “K” used by

FIG. 3D is a simplified pictorial illustration of a network meeting system constructed and operative in accordance with an embodiment of the present invention, is continuation of FIG. 3C, and shows the connection update 30 details of FIG. 3C.

FIGS. 4-6, 7A and 7B show user interface (e.g. web-page) layouts and hypertext selections in accordance with an embodiment of the present invention.

FIG. 8 shows the basic architecture for user interface (e.g. web-page) layouts.

FIG. 9 shows an overall design of the flow structure of the user interface (e.g. web-page).

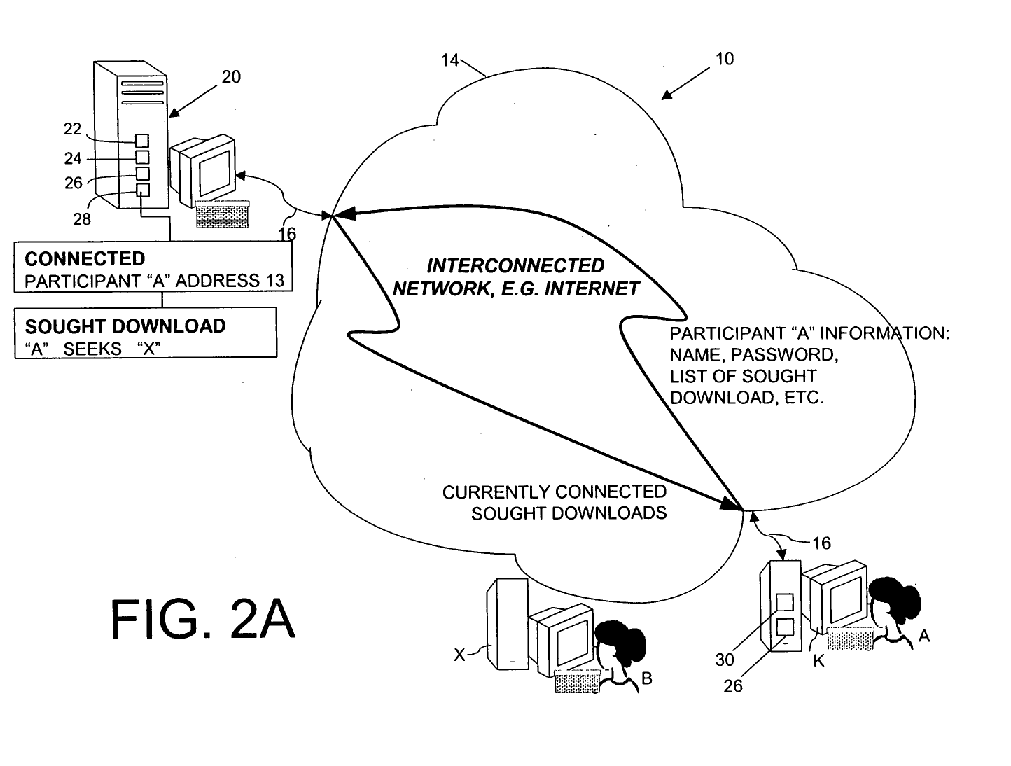

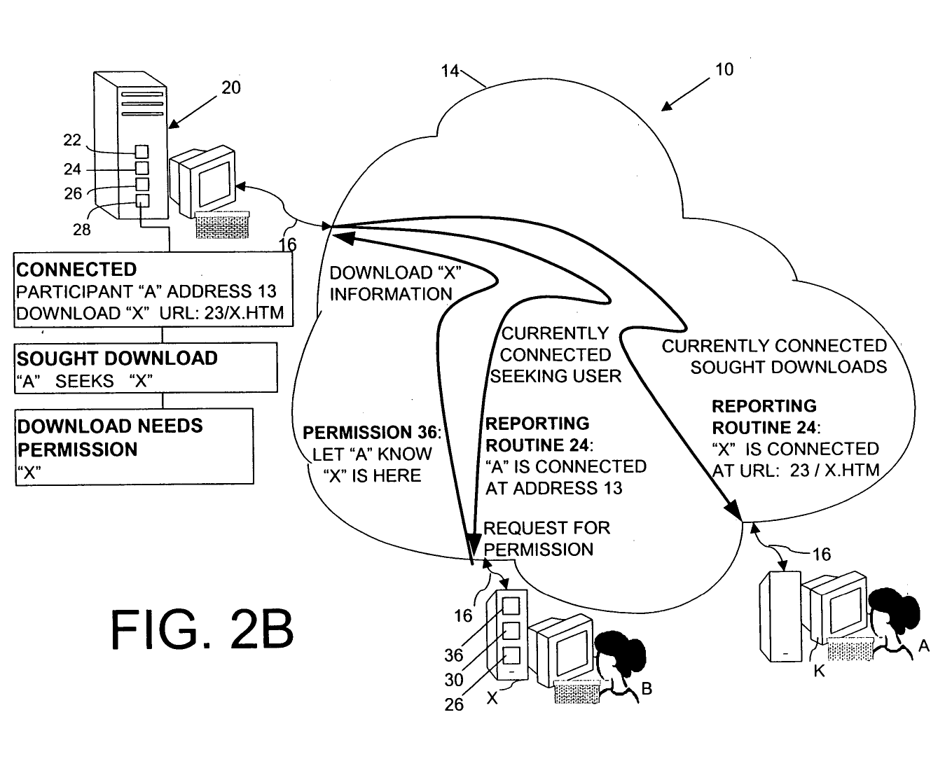

FIG. 10A is a simplified pictorial illustration of a network meeting system in accordance with an embodiment of the present invention, wherein the participant “AA” downloads the sought (meeting content) download “X” of FIG. 2B, by clicking instant message (which has hypertext-link to the URL address of the sought download “X”) from “BB”, and wherein both participants “AA” and “BB” being connected and exchanging messages using instant messaging software from Microsoft, AOL, ICQ, Yahoo!, etc.

FIG. 10B is a simplified pictorial illustration of a network meeting system in accordance with an embodiment of the present invention, is an extension of FIG. 10A, wherein the participants “AA” and “BB” download the sought (meeting content) downloads “X” and “T”, by clicking instant messages (which has hypertext-links to the URL address of the sought downloads “X” and “T”) from “BB” and “AA” respectively, and wherein both participants “AA” and “BB” being connected and exchanging messages using instant messaging software from Microsoft, AOL, ICQ, Yahoo!, etc.

FIG. 10C is a simplified pictorial illustration of a network meeting system in accordance with an embodiment of the present invention, is an extension of FIG. 10B, and participants “AA”, “BB”, “CC” and “DD” are connected and exchanges messages using instant messaging software from Microsoft, AOL, ICQ, Yahoo!, etc., and wherein:
Part 1: Setup sought (meeting content) download “T” for participants “BB”, “CC” and “DD”:
   a) connection routine 30 (of personal-server “T”) optionally creates text-message with hypertext-link to the URL address of the sought download “T” and saves said text-message in clip-board.
   b) participant “AA” sends the said clip-board text-message as instant message to participants “BB”, “CC” and “DD” (by using Control_V, i.e. pressing the two keys “Control” and “V” simultaneously, to paste the said clip-board text-message onto its instant message dialog-box and then click “send” to send the instant message to other three participants).
   c) participants “BB”, “CC” and “DD” receive said instant messages from user “CC” and click said hypertext-link (to the URL address of the sought download “T”) to download the sought download “T”;
Part 2: Setup sought (meeting content) download “X” for participants “AA”, “CC” and “DD” (similar to that in Part 1);
Part 3: Setup sought (meeting content) download “Y” for participants “AA”, “BB” and “DD” (similar to that in Part 1);
Part 4: Setup sought (meeting content) download “Z” for participants “BB”, “CC” and “DD” (similar to that in Part 1); resulting in multipoint peer-to-peer 2-way meeting.

FIG. 11 illustrates the addition to a beginning of each new update audio file a duplicate copy of (fraction of a second) end of its preceding audio file to create a slight audio overlap between chronological audio files (to repair any broken syllable at the end of audio files), in accordance with one embodiment of the invention

FIG. 12A is a simplified pictorial illustration of a network meeting system e in accordance with one embodiment of the present invention, wherein a meeting participant “A” uses edit routine 68 on “K” to open a file on computer “K” or an URL on interconnected network 14, thereby designating it as (meeting content) download “T”.

FIG. 12B is a simplified pictorial illustration of a network meeting system in accordance with one embodiment of the present invention, is continuation of FIG. 12A, wherein a seeking meeting participant “B” of FIG. 12A uses edit routine 68 on “L” to download and optionally edit (another meeting participant A's meeting content) download “T”, and saves it as its (B's meeting content) download “X”.

FIG. 12C is a simplified pictorial illustration of a network meeting system in accordance with one embodiment of the present invention, is continuation of FIG. 12B, wherein the meeting participant “A” of FIG. 12B downloads the (possibly edited-by-B meeting content) download “X” of FIG. 12B, and saves it as its updated (A's meeting content) download “T” for viewing by “B”, “C”, and “D”.

FIG. 12D is a simplified pictorial illustration of a network meeting system in accordance with one embodiment of the present invention, is alternate-to or in-addition-to FIG. 12C, wherein after “B” downloaded and optionally edited (another meeting participant A's meeting content) download “T”, A's edit routine 68 on “K” downloads from “X” to update A's (meeting content) download in wwwroot of “T” (for viewing by “B”, “C”, and “D”).

FIG. 13A is a simplified pictorial illustration of a network meeting system in accordance with one embodiment of the present invention, wherein a meeting participant “A” uses edit routine 68 on “K” to start an application (on “K” or interconnected network 14) to open a file on computer “K” or an URL on interconnected network 14, thereby designating it as (meeting content) download “T”.

FIG. 13B is a simplified pictorial illustration of a network meeting system in accordance with one embodiment of the present invention, is continuation of FIG. 13A, wherein a seeking meeting participant “B” of FIG. 13A uses edit routine 68 on “L” to download (meeting participant A's meeting content), and to pop-up copy of said application (on “L” or interconnected network 14) and to view and optionally edit said download (in the said application), and saves it as its (B's meeting content) download “X”.

FIG. 13C is a simplified pictorial illustration of a network meeting system in accordance one embodiment of the present invention, is continuation of FIG. 13B, wherein the meeting participant “A” of FIG. 13B uses edit routine 68 on “K” to operate application (started in FIG. 13A) and to download the (possibly edited-by-B meeting content) download “X” of FIG. 13B, and saves it to update (A's meeting content) download “T” for viewing by “B”, “C”, and “D”.

FIG. 13D is a simplified pictorial illustration of a network meeting system in accordance with one embodiment of the present invention, is alternate-to or in-addition-to FIG. 13C, wherein:
i. “B” uses edit routine 68 on “L” to click hypertext-link to download from “T” and to pop-up copy of application on “L”.
ii. Edit routine 68 on “L” requests and obtains application and edit control from “K”.
iii. “B” optionally uses edit routine 68 on “L” to edit and saves download to wwwroot of “X”.
iv. Edit routine 68 on “K” changes refresh-IP-address (of application image and download) from “T” to “X”.

FIG. 14 shows a flow chart of operations performed by a computer K, in accordance with one embodiment of the invention.

FIG. 15 illustrates how screen shots of varying scales may be captured, in accordance with one embodiment of the invention.

FIG. 16 shows a high-level block diagram of hardware that may be used to implement any of the computers, and servers of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, this invention provides an improved network meeting system for facilitating locating personal-server meeting content which is connected to an interconnected network, for the purposes of establishing point-to-point connection to download server content (e.g. preferably auto-updated HTML or XML web-pages, preferably auto-updated talking-images web-pages, preferably auto-updated multimedia web-pages, etc.). A personal-server's content location on an interconnected network is typically expressed in terms of the content's current URL (universal resource locator) address.

An advantage of the present invention is that an ad hoc meeting can easily be created without the need to schedule, or join the meeting at a designated time.

Another advantage of the present invention is that a meeting participant may join a meeting without having to know the URL addresses of other meeting participants' meeting contents, e.g. auto-updated audio and video-image web-pages.

Another advantage of the present invention is that a meeting participant may join a one-way meeting (e.g. to listen to and view a meeting presentation) using a web browser without the need to install any software such as browser helper application (i.e. plug-in software) or custom software.

Another advantage of the present invention is that web-page audio waits for retransmission of lost audio packets, while IP phones will not wait as long (so as to minimize audio delay), resulting in more intelligible and higher quality audio.

In addition, the network meeting system of the present invention provides at least some and preferably all of the following advantages:
a. Meeting content may be identified accurately, because each (meeting content) download has a permanent and unique (meeting content) download name; and the network address or personal-server or content can be changed or updated easily and quickly without changing the unique (meeting content) download name.
b. (Meeting content) downloads do not need fixed URL addresses or a fixed personal-server. They may be located dynamically and accurately, because each (meeting content) download has a permanent and unique (meeting content) download name.
c. (Meeting content) downloads may be located quickly and efficiently, because the network database-server and personal-servers work together to provide automatically a meeting participant who is currently connected to the network with a set of (meeting content) downloads (in at least one personal-server) who are currently connected to the network from among a predefined set of sought (meeting content) downloads whose connection status the meeting participant wishes to know.
d. Meeting participants are notified automatically when the sought (meeting content) download, in which the seeking meeting participant has an interest, connects to the network.
e. (Meeting content) downloads may protect their privacy and confidentiality by limiting who may locate them. Alternatively or additionally, privacy and confidentiality may be increased by optionally changing download (meeting content) file name to new file name using a random number or string of printable random characters.
f. If the central database-server(s) go down, currently connected meetings (and meeting content downloads) generally are not affected, as the various (meeting participants') computers and (meeting content download) personal-servers receive connection updates from their corresponding sought personal-servers and seeking computers respectively.
g. Load on central database-server(s) can be reduced during heavy usage by lengthening the intervals that the various seeking computers and sought personal-servers send connection updates to the said database-server(s). Level of service can also be specified for different types (e.g. paid versus free) of meeting participants and downloads by having longer connection update intervals for participants and downloads with lower service levels.
h. Network meetings can be instant, multipoint, and multimedia with a lot less complexity and cost compared to existing systems on the market, with participants optionally using web browsers (and not needing to install custom software).

It is noted that throughout the specification and claims the term “meeting participant” encompasses any entity, preferably human, that operates a computer or other communications terminal or personal-server, preferably for the purpose of connecting to (meeting content) downloads (in at least one personal-servers) to download (meeting content) via an interconnected network. It is further noted that the term “seeking meeting participant” encompasses any meeting participant who wishes to locate at least one (meeting content, typically in personal-server) download currently connected to the interconnected network. It is also noted that the meeting participant name can be any non-blank string of printable characters, including (but not limited to numbers, alphanumeric characters, printable characters, etc. of any length, and can be in any language. The network meeting system of the present invention may be used to complement and build on existing instant messaging services, and the term “meeting participant” can be simultaneously an instant messaging user.

It is noted that throughout the specification and claims, the term “computer” encompasses any computer, communications terminal or device or apparatus. It is further noted that the term “personal-server” encompasses any server, computer or communications terminal or device or apparatus with server capability (e.g. by installing server software in computer or incorporating server capability in read-only-memory ROM). It is further noted that the term “database-server” encompasses any server with database capability, e.g. by having database software installed, or any computer with server and database capability, e.g. by having server and database software installed.

It is noted that the term “download” encompasses any broadcast (i.e. download) of meeting content (including but not limited to website, HTML or XML web-pages, images, audio, talking-images, video, multimedia, java, Microsoft.Net, applets, computer files (including zipped folder of computer files), etc. for preferably TCP/IP network) from any personal-server (preferably WWW (world wide web) server or FTP (file transfer protocol) server for preferably TCP/IP network) which may or may not have fixed or dynamic network URL (universal resource location) address, and which may or may not be operated by human, and whose location, typically a network URL address, is desired by a seeking meeting participant.

It is further noted that the term “download” may be (but not limited to) one or more of the following:
a) HTML (hypertext mark-up language) or XML (Extensible Markup Language) page preferably using frames (to allow multiple frames or “sub-pages” on the HTML or XML web-page to be downloaded using one URL address for the web-page);
b) audio web-page or pages that preferably after download auto-plays embedded audio file or files (preferably compressed in industry standard format, e.g. .wav);
c) image web-page or pages displaying image or images (e.g. video-image or images from one or more cameras connected to corresponding personal-server either by cable(s) or wirelessly, or video-image or images from a local or remote database) preferably compressed in industry standard format (e.g. JPEG), with
   mouse-image (optionally added-to and appearing on said video-image or images, by meeting participant's custom software) at the location of meeting participant's PC mouse (relative to video-image on its PC monitor);
d) video web-page or pages displaying video or videos (e.g. video created from captured audio from microphone, line-in, etc. and tele-images from one or more cameras connected to corresponding personal-server either by cable(s) or wirelessly, captured video from streaming multimedia, etc., or video or videos from a local or remote database) that preferably after download auto-plays embedded video file or files (preferably compressed in industry standard format, e.g. avi, mpeg4) with or without audio;
e) talking-image web-page or pages:
   (i) displaying image(s) (e.g. captured image of PC active-window) of opened document (e.g. Microsoft Office document), opened application (e.g. Microsoft Word), opened image file, website web-page displayed on web browser, playing animation, playing multimedia, playing streaming multimedia, etc., or image or images from a local or remote database) preferably compressed in industry standard format (e.g. JPEG), with
      mouse-image (optionally added-to and appearing on said video-image or images, by meeting participant's custom software) at the location of meeting participant's PC mouse (relative to video-image on its PC monitor);
   (ii) preferably has hypertext-link(s) to said document, saved-file of one being-displayed by said opened application, said image file, said web-page, said animation, said multimedia, said streaming multimedia, etc. to allow (optionally) original document/saved-file-of-one-being-displayed-by-opened-application/image/web-page/URL/animation/multimedia/streaming-multimedia/etc file(s) download and display by seeking meeting (content-download) participants (to view and optionally edit meeting contents: original document, saved-file-being-displayed-by-said-opened-application, original images, original web-page or URL, original animation, original streaming multimedia, etc., instead of being limited to viewing-only of captured Windows PC window image of said meeting contents); and said original image file, said original document, said saved-file-being-displayed-by-said-opened-application, said original web-page file(s) or URLs, etc. are automatically copied, if necessary, to the personal-server's world wide web (typically called “wwwroot”) directory (or sub-directory); and
      said seeking meeting (content-download) participants optionally use custom software on their PCs to:
         View and optionally edit said downloaded original document, original saved-file-being-displayed-by-opened-application, original images, original web-page or URL, original animation, original streaming multimedia, etc.
         Auto-save periodically (e.g. every few seconds) the (now-edited) downloaded said document, said save-file, said images, said web-page or URL, said animation, etc. to said seeking meeting (content-download) participants' personal webservers' Internet WWW root directories (as meeting contents of said seeking meeting (content-download) participant, available for others to download).
   (iii) preferably auto-plays embedded audio file or files (e.g. captured audio from microphone, line-in, or streaming multimedia, preferably compressed in industry standard format, e.g. .wav, or audio file or files from a local or remote database) after download; and
f) file (e.g. document file) download web-page that meeting (content-download) participant can click hypertext-link to download the original file, and that preferably Internet Explorer or custom software can open and display and allow meeting (content-download) participant to edit original file after download, and to auto-save periodically now-edited file to meeting (content-download) participant's personal webserver Internet world wide web (typically called “wwwroot”) directory (or sub-directory, as meeting (content-download) participant's meeting content (for others to download).
g) animation, multimedia (e.g. video, slideshow, etc.) or streaming multimedia web-page that either auto-plays or user-click-to-play an embedded animation or multimedia or streaming multimedia file (preferably in industry standard format, e.g. Windows media video .wmv format);
h) computer file download web-page that meeting participant can click hypertext-link to download a computer file (including zipped folder of computer files), save it, or optionally open it and display the said file on Internet explorer or custom software;
i) index, default, custom web-page, or URL or any web-page from any Internet web-site, which using hypertext-link allows meeting participant to surf a (meeting content) download's whole or partial website, or any said URL, web-page or website on the Internet.

It is further noted that:
1. (In the further note for “download” above), it is also noted that said audio HTML or XML web-page or pages is preferably auto-updated by:
   i) saving periodically (e.g. every few seconds) the new update audio file or files (e.g. captured audio from microphone, line-in, streaming multimedia, etc., or audio file or files from a local or remote database) to the corresponding personal-server's world wide web (typically called “wwwroot”) directory (or sub-directory, where the said audio web-page(s) or file(s) is located) or optionally to a local or remote database), and
   ii) add to beginning of each new update audio file a duplicate copy of (fraction of a second) end of its preceding audio file to create a slight audio overlap between chronological audio files (to repair any broken syllable at the end of audio files), and
   iii) said audio web-page or pages download is preferably auto-refreshed by using HTML refresh computer code (or XMLHTTP object, or JavaScript code, etc.), and
   iv) auto-refresh time of each of the said audio web-page is auto-set to equal to or slightly longer (to allow for Internet delay, etc.) than the audio play-time of each of the said audio web-page.
2. It is also noted that said video HTML or XML web-page or pages is preferably auto-updated by:
   i) saving periodically (e.g. every few seconds) the new update video file or files (e.g. video created from captured audio from microphone and tele-images from camera(s) connected to corresponding personal-server either by cable(s) or wirelessly, captured video from streaming multimedia, etc., or video-image or images from a local or remote database) to the corresponding personal-server's world wide web (typically called “wwwroot”) directory (or sub-directory, where said video web-page(s) or file(s) is located) or optionally to a local or remote database).
   ii) add at beginning of each new update video file a (fraction of a second) duplicate copy of (fraction of a second) end of its preceding video file to create a slight video overlap between chronological video files (to repair any broken syllable at the end of audio in the video files), and
   iii) said video web-page or pages download is preferably auto-refreshed by using HTML refresh computer code (or XMLHTTP object, or JavaScript code, etc.), and
   iv) auto-refresh time of the said video web-page is auto-set to equal to or slightly longer (to allow for Internet delay, etc.) than the video play-time of the video web-page.
3. It is also noted that said talking-image HTML or XML web-page or pages is preferably auto-updated by:
   i) saving periodically (e.g. every few seconds) the new update audio file or files (e.g. captured audio from microphone, line-in, streaming multimedia, etc., or audio file or files from a local or remote database) to the corresponding personal-server's world wide web (typically called “wwwroot”) directory (or sub-directory, where said talking-image web-page(s) or file(s) is located) or optionally to a local or remote database, and
   ii) add at beginning of each new update audio file a duplicate copy of (fraction of a second) end of its preceding audio file to create a slight overlap between chronological audio files (to repair any broken syllable at the end of audio files), and
   iii) saving periodically (e.g. every few seconds) the new update image(s) (e.g. captured image of PC active-window) of opened document (e.g. Microsoft Office document), opened file of opened application (e.g. Microsoft Word), opened image file, website web-page or URL, playing animation, playing multimedia, playing streaming multimedia, etc., or image file or files from a local or remote database) to the same personal-server's world wide web (typically called “wwwroot”) directory (or sub-directory, where said talking-image page(s) or file(s) is located); and said document, saved-file-of-one-being-displayed-by-opened-application, said image file, said website web-page, said animation, said multimedia, said streaming multimedia, etc. are automatically copied (to update), if necessary (optionally from a local or remote database), to the personal-server's wwwroot directory (or sub-directory); and
   iv) updating periodically (e.g. every few seconds) the hypertext-link(s) to said image file, said document, saved-file of one being-displayed by said opened application, said website web-page or URL, said animation, said multimedia, said streaming multimedia, etc. to allow (optionally) original document/saved-file-of-one-being-displayed-by-opened-application/image/web-page/animation/multimedia/streaming-multimedia/etc file(s) download and display by other meeting participants (to view and optionally edit meeting contents: original document, saved-file-of-one-being-displayed-by-opened-application, original images, original web-page or URL, original animation, original multimedia, original streaming multimedia, etc., instead of being limited to viewing-only of captured Windows PC window image of said meeting contents);
   v) said talking-image web-page or pages download is preferably auto-refreshed by using HTML refresh computer code (or XMLHTTP object, or JavaScript code, etc.), and
   vi) the auto-refresh time of each of said talking-image web-page is auto-set to equal to or slightly longer (to allow for Internet delay, etc.) than the audio play-time of each of said talking-image web-page.
4. It is also noted that said animation/multimedia/streaming-multimedia HTML or XML web-page or pages is preferably auto-updated by:
   i) saving periodically (e.g. every few seconds) the new update animation/multimedia/streaming-multimedia web-page or pages to the corresponding personal-server's world wide web (typically called “wwwroot”) directory (or sub-directory, where said animation/multimedia/streaming-multimedia page(s) or file(s) is located), and said animation/multimedia/streaming-multimedia web-page or pages download is preferably auto-refreshed (e.g. at interval somewhat longer than the playtime of the animation/multimedia/streaming-multimedia) by using HTML refresh computer code (or XMLHTTP object, or JavaScript code, etc.); and
   ii) updating periodically (e.g. every few seconds) the hypertext-link(s) to said animation/multimedia/streaming-multimedia content for download by updating the animation/multimedia/streaming-multimedia URL address in the hypertext-link in said update animation/multimedia/streaming-multimedia web-page or pages.
5. It is also noted that said computer file download HTML or XML web-page or pages is preferably auto-updated by:
   i) saving periodically (e.g. every few seconds) the new update computer file download web-page to the corresponding personal-server's world wide web (typically called “wwwroot”) directory (or sub-directory, where said computer file download web-page(s) or file(s) is located), and said computer file download web-page or pages download is preferably auto-refreshed (e.g. every few seconds) by using HTML refresh computer code (or XMLHTTP object, or JavaScript code, etc.); and
   ii) updating periodically (e.g. every few seconds) the hypertext-link(s) to said computer file (including zipped folder of computer files) for download broadcast by updating its computer file download URL address in the hypertext-link in said update computer file download web-page or pages.
6. It is also noted that said index, default, or other HTML or XML web-page or pages, or URL or any web-page from any Internet web-site, is preferably auto-updated by saving periodically (e.g. every few seconds) the new update index, default, or other web-page or pages, or URL or any web-page from any Internet web-site, to the corresponding personal-server's world wide web (typically called “wwwroot”) directory (or sub-directory, where said index, default, or other web-page(s) or file(s), or URL or any web-page from any Internet web-site, is located), and said index, default, or other web-page, etc. download may be preferably auto-refreshed (e.g. every few seconds) by using HTML refresh computer code (or XMLHTTP object, or JavaScript code, etc.).

It is further noted that “download name” encompasses name for any (meeting content) download from any personal-server, and that “download” encompasses any (meeting content) download from at least one personal-server, including multiple downloads (implying multiple download names) from single personal-server which may be next to or physically removed from computer or meeting participant.

It is further noted that the confidentiality of any (meeting content) download or download URL can be significantly increased by optionally changing the (meeting content) download file name to new file name using a random number or a string of printable random characters. The new file name (and meeting content download URL address) can optionally or additionally be made unique by appending the unique download name (e.g. RandomString_UniqueDownloadName.htm).

It is further noted that the confidentiality of any (meeting content) download or (meeting content) download URL can be further increased by changing the (meeting content) download URL and (meeting content) download file name regularly, e.g. for every new meeting or new network connection, by the personal-server's connection routine and replacing the old meeting content file (using old meeting content download file name) with the new meeting content file (using the new meeting content download file name).

It is also noted that multiple (meeting content) downloads can use at least one personal-server (of an ISP, Internet portal, company server, etc.), and have unique URL address for each (meeting content) download (in the same said at least one personal-server) for participants to download, by adding the unique (meeting content) download name to each of its corresponding meeting content download file names.

There is thus provided in accordance with one embodiment of the present invention a network meeting system including an interconnected network, various computers and personal-servers which are connectable to the interconnected network and which can be used by meeting participants to download from personal-servers via the interconnected network, the meeting participant and (meeting content) download not necessarily being identified with a given computer and personal-server respectively, a method for monitoring notifications (from connection routine of various computers and personal-servers) that a meeting participant or a (meeting content) download is currently connected or become connected or become disconnecting to the interconnected network irrespective of which of the various computers and personal-servers that meeting participant and (meeting content) download is employing, and a method for reporting to:
a) a seeking meeting participant, when first connected to said interconnected network via any of said various computers, network connection status information relating to (meeting content) downloads who are in a set of sought (meeting content) downloads which set includes the unique (meeting content) download names or other identification indicia of the sought (meeting content) downloads, which set is defined by and sent by said seeking meeting participant, and for providing to said seeking meeting participant the current URL address for sought (meeting content) download for each of said sought (meeting content) downloads for that said (meeting content) download current connection to said interconnected network, thereby enabling (meeting content) download between said seeking meeting participant and any of said sought (meeting content) downloads; and
b) a (sought) personal-server who a sought (meeting content) download is using, when first connected to said interconnected network, network connection status information relating to seeking meeting participant(s) who is/are seeking the sought (meeting content) download (identified by unique download name) from said (sought) personal-server, and for providing to said (sought) personal-server the current network address for said seeking meeting participant's current connection to said interconnected network.

Further in accordance with one embodiment of the present invention, any of the meeting participants and (meeting content) download may function as at least one of a seeking meeting participant if said meeting participant employs a computer, and as at least one of a sought (meeting content) download if said (meeting content) download employs a personal-server (which may be server software installed in a computer). A meeting participant may use its meeting participant name to setup its (meeting content) download if it also employs a personal-server (e.g. by installing server software on its computer). A (meeting content) download name must be unique and different from all meeting participant names (and all other download names), unless a meeting participant uses its meeting participant name to setup its (meeting content) download, in which case the meeting participant name and (meeting content) download name can be one and the same.

Still further in accordance with one embodiment of the present invention, any of the meeting participants may function simultaneously as a seeking meeting participant if said meeting participant employs a computer, and a sought (meeting content) download if said meeting participant broadcasts (i.e. allows other participants to download said participant's meeting content) by employing a personal-server (which may be server software installed in said meeting participant's computer).

Further in accordance with one embodiment of the present invention, the network connection status information includes an indication that a seeking meeting participant or sought (meeting content) download is currently connected to the interconnected network.

Additionally in accordance with one embodiment of the present invention, the network connection status information includes an indication that a seeking meeting participant or sought (meeting content) download is currently become connected to the interconnected network.

Moreover in accordance with one embodiment of the present invention, the network connection status information includes an indication that a seeking meeting participant or sought (meeting content) download is currently become disconnected from the interconnected network.

Further in accordance with one embodiment of the present invention, at least one of the meeting participants or (meeting content) downloads has a unique meeting participant name or a unique (meeting content) download name, but a meeting participant may use its meeting participant name to setup its (meeting content) download, e.g. if its computer has personal-server functionality such as by installing server software.

Still further in accordance with one embodiment of the present invention, the unique meeting participant name or (meeting content) download name is independent of any computer (or personal-server).

Additionally in accordance with one embodiment of the present invention, at least one database-server is connected to the interconnected network, and the database-server daemon software for monitoring notification (from connection routine of various computers and personal-servers that a meeting participant or (meeting content) download is currently connected or become connected or become disconnected to said interconnected network) is resident in said at least one database-server, and said computer and personal-server connection routine reside in the various computers and personal-servers.

Further in accordance with one embodiment of the present invention, at least one database-server is connected to the interconnected network, and the reporting routine (e.g. CGI program or custom software) for reporting to seeking meeting participant and sought (meeting content) download's personal-server is resident in the said at least one database-server.

Further in accordance with one embodiment of the present invention, the connection routine (e.g. custom software) to notify when first connected and then periodically (at intervals changeable, e.g. by database-server) that at least one of said meeting participants or said (meeting content) downloads is currently connected or become connected or become disconnecting to said interconnected network is resident in the various computers and personal-servers.

Moreover in accordance with one embodiment of the present invention, the network meeting system includes software for notifying when first connected and then periodically (at intervals changeable, e.g. by database-server) that at least one of the seeking meeting participants or sought (meeting content) download is currently connected or become connected or become disconnecting to the interconnected network.

Further in accordance with one embodiment of the present invention, at least one of the meeting participants is currently connected to the interconnected network and has a network address, and the network meeting system includes address routine for determining the network address.

Still further in accordance with one embodiment of the present invention, at least one of the (meeting content) downloads is currently connected to the interconnected network and has a network URL address, and the network meeting system includes address routine for determining the network URL address.

Additionally in accordance with one embodiment of the present invention, the routine for determining (network and URL address) is resident in any of the various computers and personal-servers.

Moreover in accordance with one embodiment of the present invention, at least one database-server is connected to the interconnected network, and the address routine for determining (network and URL address) is alternatively or additionally resident in the at least one database-server.

Further in accordance with one embodiment of the present invention, the network meeting system includes software for authorizing whether the at least one seeking meeting participant may access any of the information relating to the sought (meeting content) download.

Still further in accordance with one embodiment of the present invention, the software for authorizing is resident in any of the various personal-servers (or in computers with server software installed).

Additionally in accordance with one embodiment of the present invention, the network meeting system includes software for maintaining information regarding any of the meeting participants or (meeting content) downloads.

Moreover in accordance with one embodiment of the present invention, the software for maintaining information is resident in at least one database-server connected to the interconnected network, and is alternatively or additionally resident in the various computers and personal-servers, in which case the software (in various computers and personal-servers) for maintaining information may be different.

Further in accordance with one embodiment of the present invention, at least one of the meeting participants or (meeting content) downloads (personal-servers) provides information to the software (in database-server, various computers, or personal-servers) for maintaining information.

Still further in accordance with one embodiment of the present invention, the information includes data on seeking meeting participants and sought (meeting content) downloads, if any, and not all data (i.e. only a subset of data) is provided to various computers and personal-servers.

Additionally in accordance with one embodiment of the present invention, the information comprises a request to a sought (meeting content) download (personal-server) to permit whether a seeking meeting participant may access any of the information relating to the sought (meeting content) download.

There is also provided in accordance with one embodiment of the present invention a method for indicating network connection information relating to meeting participants and (meeting content) downloads (from personal-servers), the method including monitoring notification (from connection routine of various computers and personal-servers) that a meeting participant or a (meeting content) download is currently connected or become connected or become disconnecting to an interconnected network via any of various computers or personal-servers, and reporting to:
a) a seeking meeting participant, when first connected to said interconnected network via any of said various computers, network connection status information relating to (meeting content) downloads who are in a set of sought (meeting content) downloads which set includes the unique (meeting content) download names or other identification indicia of the sought (meeting content) downloads, which set is defined by and sent by said seeking meeting participant, and for providing to said seeking meeting participant the current URL address for sought (meeting content) download for each of said sought (meeting content) downloads for that said (meeting content) download current connection to said interconnected network, thereby enabling said seeking meeting participant to download any of said sought meeting content (downloads); and
b) a (sought) personal-server who a sought (meeting content) download is using, when first connected to said interconnected network, network connection status information relating to a seeking meeting participant who is seeking the sought (meeting content) download (identified by unique (meeting content) download name) from said (sought) personal-server, and for providing to said (sought) personal-server the current network address for said seeking meeting participant's current connection to said interconnected network.

Further in accordance with a preferred embodiment of the present invention, at least one of the meeting participants or (meeting content) downloads has a unique meeting participant or (meeting content) download name.

Still further in accordance with a preferred embodiment of the present invention, the unique meeting participant or (meeting content) download name is independent of any computer or personal-server.

Reference is now made to FIG. 2A which is a simplified pictorial illustration of a network meeting system 10 constructed and operative in accordance with an embodiment of the present invention.

A network meeting system 10 is setup to include various computers “T” and personal-servers “T” and “X” (which may be server software installed in various computers “T”) connectable to an interconnected network 14 (e.g. LAN, WAN, Internet, etc.) via various connection means 16 (e.g. dial-up, leased line, wireless LAN, etc.), which may either be wired or wireless. Computer “K” and personal-servers “T” (and “X”) can receive input from and display output to meeting participant “A”, and to transmit and receive information via interconnected network 14 to and from at least one database-server 20 that is also connected to interconnected network 14 via connection means 16. Database-server 20 can also send and receive information via interconnected network 14.

Meeting participant “A” starts network-browser/custom-software and connection routine 30 on computer “K” (and preferably personal-server “T”), which is connected to interconnected network 14. Address routine 26 preferably resides in computer “K” (and personal-server “T”), where address routine 26 (e.g. custom C++ software using Microsoft Winsock API (Application Programmer's Interface) extracts the IP address of computer “K” (and personal-server “T”) from the HOSTENT structure which is a data structure allocated by Windows Sockets and which is used by the C++ programming language Windows functions and stores information about a given host, such as host name, IP address, and so forth) determines the network address of computer “K” (and the URL address of sought meeting content download in personal-server “T” or “X”) when a connection to interconnected network 14 is established, and provides the network address (and URL address) to network browser (or custom software) and connection routine 30.

Network browser/custom-software and connection routine 30 transmits a notification when first connected and then periodically (at intervals changeable, e.g. set by database-server 20) via interconnected network 14 to server daemon 22 (e.g. HTTPD or Hypertext Transfer Protocol daemon or program that waits in attendance for requests to come in from the rest of the Internet), which can receive input via interconnected network 14, and which resides typically in database-server 20. Meeting participant “A” enters user data (participant name, password, etc.) on computer “K” (or personal-server “T”). Said participant “A” data together with said network address (and URL address) information (from address routine 26) are sent from connection routine 30 and received by server daemon 22 and provided to server database 28 (e.g. Microsoft SQL database), where participant information, network and URL address is maintained.

On data-base server 20, a different address routine 26 (e.g. CGI program obtains a seeking meeting participant's IP address from the CGI environment variable REMOTE.sub-ADDR and stored in server database) may alternatively or additionally determine the source network address (e.g. IP address) of the notification received by server daemon 22. Said different address routine 26 may alternatively or additionally provide the network (and URL) address to server database 28 (e.g. Microsoft SQL database), and may alternatively or additionally be resident in database-server 20, where the network (and URL) address is maintained.

A reporting routine 24 (e.g. CGI program) in database-server 20 retrieves information maintained by server database 28 and transmit this information to various computers “T” and personal-servers “T” (and “X”).

A typical operation of network meeting system 10 is described in detail below with reference to FIGS. 2A, 2B, 3A and 3B.

Reference is now made to FIG. 2A which shows a meeting participant “A” establishing a connection to an interconnected network 14 (e.g. LAN, WAN, Internet, etc.) using a computer “K” (and preferably personal-server “T”) via connection means 16. The connection to interconnected network 14 may be fixed line or wireless, and is typically via a leased line (e.g. DSL, ISDN, Ti, wireless LAN) or dial-up line (e.g. POTS, GSM/CDMA/3G) to a network communications service provider, typically an Internet Service Provider (ISP) or telecom company.

At least one database-server 20 is typically continually connected to the interconnected network 14 via connection means 16. More than one database-server 20 may be provided wherein all database-servers are continually synchronized to have the same information.

Once meeting participant “A” is connected to interconnected network 14, meeting participant “A” uses network browser (or custom software) and connection routine 30 to notify (when first connected and then periodically at intervals changeable, e.g. set by database-server) server daemon 22 that meeting participant “A” is connected to interconnected network 14. This notification includes a unique meeting participant name predefined for meeting participant “A” and maintained in a list of connected meeting participants by server database 28. This unique meeting participant name is independent of the computer “K” used by meeting participant “A”. In one embodiment, this notification may comprise a meeting participant password for authentication that the participant “A” has authority to use the unique meeting participant name. This notification may also include other information such as the current network (and URL) address for computer “K” (and personal-server “T”) used by meeting participant “A”.

Address routine 26 (on computer “K”) determines the current network address of meeting participant “A” when computer “K” is connected to interconnected network 14. Address routine 26 (on computer “K”) is operative to use Microsoft Winsock API to extract the network (and URL) address of computer “K” (and personal-server “T”) from the HOSTENT structure which is a data structure allocated by Windows Sockets and which is used by the C++ programming language Windows functions to store information about a given host, such as host name, network address, etc. Address routine 26 (on computer “K”) then communicates network (and URL) address to connection routine 30, which then communicates to (database-)server daemon 22, when computer “K” is first connected and then periodically at intervals changeable, e.g. set by the database-server. The current network (and file-sharing/download URL) address for meeting participant “A” (i.e. computer “K” and personal-server “T”) is then provided to (database-)server database 28 which maintains the network (and URL) address in the list of connected meeting participants (e.g. computers “T”) and meeting content downloads (in personal-servers “T” and “X”).

On database-server 20, a different address routine 26 (e.g. a CGI program obtains a seeking meeting participant 's IP address from the CGI environment variable REMOTE.sub-ADDR and store in server database 28) may alternatively or additionally determine the source network address (e.g. IP address) of the notification received by server daemon 22. Said different address routine 26 may alternatively or additionally provide the network (and URL) address to server database 28 (e.g. Microsoft SQL database), and may alternatively or additionally resident in database-server 20, where the network (and URL) address is maintained.

While said different address routine 26 communicates with database-server database 28 as mentioned above, said different address routine 26 (on database-server 20) may alternatively or additionally communicate with computer “K” (and personal-servers “T” and “X”), providing the computer “K” (and personal-servers “T” and “X”) current network (and URL) address to network browser (or custom software) and connection routine 30 on computer “K” (and personal-servers “T” and “X”).

Computer “K” provides a set of sought (meeting content) downloads predefined by meeting participant “A” to server database 28 which maintains it. Server database 28, upon receipt of a set of sought (meeting content) downloads from meeting participant “A” at computer “K”, checks the list of connected (meeting content) downloads for any sought (meeting content) downloads that are currently connected to interconnected network 14, typically for display on the computer “K”. If connected sought (meeting content) downloads are found, server database 28 causes reporting software 24 (e.g. CGI program) to transmit a report to meeting participant “A” at computer “K” wherein the report typically includes the unique (meeting content) download names and (preferably their hypertext links to) URL addresses for all sought (meeting content) downloads who are currently connected to interconnected network 14 and who meeting participant “A” (i.e. computer “K”) is seeking.

Server daemon 22 receives connection updates from connection routine 30 of computer “K” (when first connected and then periodically at intervals changeable, e.g. by database-server 20) that computer “K” is currently connected or disconnected to interconnected network 14 in accordance with network communications protocols well known in the art, such as TCP/IP.

Reference is now made to FIG. 2B which shows download “X” (in personal-server “X”, named differently from download “T” and personal-server “T” for purpose of easier reading and avoiding confusion) establishing a connection to interconnected network 14 in the same manner as described for meeting participant “A” (i.e. computer “K” or personal-server “T”) in FIG. 2A. Once download “X” (in personal-server “X”) is connected, server database 28 checks the list of sought (meeting content) downloads and their corresponding seeking meeting participants to determine if (meeting content) download “X” (in personal-server “X”) is sought by meeting participant “A”. If so, server database 28 then checks the list of connected meeting participants to determine if meeting participant “A” is currently connected. If meeting participant “A” is still connected, server database 28 causes reporting routine 24 (e.g. a CGI program) to transmit a report to meeting participant “A” (i.e. computer “K”), wherein the report typically includes the unique (meeting content) download name (e.g. download “X”) for sought (meeting content) download “X”, and the current network URL address (e.g. 222/D2.HTM, referring to FIG. 2B) for sought (meeting content) download “X”.

According to another embodiment of the present invention server database 28 checks the list of (meeting content) downloads who wish to be asked for permission to determine if (meeting content) download “X” wishes to explicitly permit requests from seeking meeting participants for information regarding (meeting content) download “X”. If explicit permission is required from (meeting content) download “X”, reporting routine 24 (e.g. a CGI program) transmits a request for permission to permission routine 36 (e.g. custom software checking seeking meeting participant name and/or password against a list of permitted meeting participants and password in personal-server “X”), typically resident in personal-server “T” (and “X”). Permission routine 36 (in personal-server “X”) permits or declines the request from meeting participant “A” for URL address location or other information relating to (meeting content) download “X”. Permission routine 36 then provides the permission information to server database 28 which determines what reporting routine 24 (e.g. CGI program) will transmit (i.e. permission approved or denied) to meeting participant “A” (i.e. computer “K”).

Server daemon 22 receives connection updates from connection routine 30 of personal-servers “X” (and “T”) when first connected and then periodically at intervals changeable (e.g. by database-server), that (meeting content) download “X” (in personal-server “X”) is currently connected or disconnected to interconnected network 14 in accordance with network communications protocols well known in the art, such as TCP/IP.

Reference is now made to FIG. 3A which shows meeting participant “A” (i.e. computer “K”) making a point-to-point connection to download sought (meeting content) download “X” (in personal-server “X”) using the network URL address of sought (meeting content) download “X” as provided by reporting routine 24 (e.g. CGI program) as described above with reference to FIGS. 2A and 2B. It will be appreciated that meeting participant “A” may establish a point-to-point connection to download (meeting content) download “X” once meeting participant “A” possesses the network URL address of (meeting content) download “X” independent of the present invention.

FIG. 3B is continuation of FIG. 3A, and illustrates two-way download (or meeting), wherein preferably the meeting participant “A” of FIG. 3A specifies a 2-way-auto-download (FIG. 7A) so that computer “L” (used by participant “B”) will promptly call-back personal-server “T” (used by participant “A”) to auto-download the (meeting content) download “T”, after computer “L” (used by participant “B”) receives the URL address of (meeting content) download “T” (from connection update 30 of computer “K” used by “A”).

Alternatively or additionally to using said 2-way-auto-download (in FIGS. 3B and 7A) to establish 2-way download, meeting participant “B” (using computer “L”) may make a point-to-point connection to download sought (meeting content) download “T” using the network URL address of sought (meeting content) download “T” as provided by reporting routine 24 (e.g. CGI program) as described above with reference to FIGS. 2A and 2B, resulting in two-way (meeting content) download between participants “A” (using computer “K” & personal-server “T”) and participant “B” (using computer “L” & personal-server “X”).

Reference is now made to FIG. 3C which is continuation of FIG. 3B, and illustrates multipoint peer-to-peer two-way meeting, wherein the meeting participant “A” of FIG. 3A specifies an N-way-auto-download (FIG. 7B) so that both of the following happens:
a) call-back auto-download: computers “L”, “M”, “N” (used by participants “B”, “C”, “D” respectively) will promptly call-back personal-server “T” (used by participant “A”) to auto-download the (meeting content) download “T”, after computers “L”, “M”, “N” receive the URL address of (meeting content) download “T” (from connection routine 30 of computer “K” used by “A”).
b) call-around auto-download (by computers “L”, “M”, “N”):
   i) Computer “L” call-around to download from “Y” and “Z”, after computer “L” receives the URL addresses of downloads “Y” and “Z” (from connection routine 30 of computer “K” used by “A”);
   ii) Computer “M” call-around to download from “X” and “Z”, after computer “M” receives the URL addresses of downloads “X” and “Z” (from connection routine 30 of computer “K” used by “A”);
   iii) Computer “N” call-around to download from “Y” and “Z”, after computer “N” receives the URL addresses of downloads “X” and “Y” (from connection routine 30 of computer “K” used by “A”).

FIG. 3D is a simplified pictorial illustration of a network meeting system constructed and operative in accordance with a one embodiment of the present invention, is continuation of FIG. 3C, and shows the connection update 30 details of multipoint peer-to-peer two-way meeting in FIG. 3C.

One method for constructing a network meeting system of the present invention is now described:

Construct an interconnected network 14 such as a LAN (local-area network) or a WAN (wide-area network) using a network protocol such as TCP/IP, or provide access to an interconnected network 14 such as the Internet.

Connect a computer “K”, such as an Intel-based computer using the Microsoft Windows operating system, and a personal-server “T” (e.g. by installing Microsoft Personal Web Server (pws10a.exe) or Microsoft Internet Information Server (IIS 3.0 or later) on the same or different computer), to the interconnected network 14.

Connect a database-server 20, such as an Intel-based computer operating the Windows 2000 advanced server operating system with database software (e.g. Microsoft SQL database) installed, to the interconnected network 14 at a designated network IP address, or at a designated site such as “http://www.databaseserver.com” if the interconnected network 14 is the Internet.

A meeting participant “A” using a web browser (or custom software) on computer “K” may go to the database-server 20 at the designated network address, or designated site “http://www.databaseserver.com” if the interconnected network 14 is the Internet. At this site, referring to FIG. 4, the meeting participant “A” may enter its meeting participant name and password, and click My Shared File (31) selection (with My Shared File download preferably from personal-server “T” is installed in meeting participant's computer “K”) or click Sought Download (33) selection.

Referring to FIG. 5, the My Shared File selection (31) provides the meeting participant “A” with a form asking for information pertinent to My Shared File (i.e. meeting content download “T” by other meeting participants typically from its personal-server “T”), information such as My Shared File name (download “T” in FIG. 5), personal-server (network) IP address and My Shared File (in personal-server “T”), and broadcast type. The meeting participant “A” may typically browse its personal-server “T” world wide web (WWW) root directory for its My Shared File (typically HTML or XML web-page that would be available for other participants to download as meeting content). The meeting participant “A” may enter a network IP address for its personal-server “T”; if the meeting participant's computer “K” has a personal-server “T” address routine 26 installed, preferably address routine 26 extracts the network IP address from Windows HOSTENT as explained above, or alternatively database-server 20 (different) address routine 26 may use CGI environment variable REMOTE.sub-ADDR (using database-server CGI script 58, referring to FIG. 8). Personal-server “T” network IP address (e.g. IP1.IP2.IP3.IP4) and My Shared File name (e.g. MyBroadCastFileName.htm) is concatenated together to form the URL (universal resource locator) address of My Shared File (e.g. http://IP1.IP2.IP3.IP4/MyShared FileFileName.htm, or 111/D1.HTM for download “T” in FIG. 3B). With the said My Shared File (meeting content) download “T” URL address, other meeting participants may download and display on their web browser the My Shared File, i.e. (meeting content) download “T”, of meeting participant “A” via the interconnected network 14, e.g. Internet. (The terminology for My Shared File (meeting content download “T”) then becomes other meeting participants' sought meeting content download “T”.)

If My Shared File type is private, the meeting participant “A” may enter password (136 in FIG. 5) required for its My Shared File (meeting content) download “T”, or select permitted meeting participants (35) selection to add, delete, review meeting participant names permitted (refer to FIG. 6) to download its My Shared File.

My Shared File (referring to FIG. 5) of participant “A” may be (but not limited to) one or more of the following:
a) HTML (hypertext mark-up language) or XML (Extensible Markup Language) page preferably using frames (to allow multiple frames or “sub-pages” on the HTML or XML web-page to be downloaded using one URL address for the web-page);
b) audio web-page or pages that preferably after download auto-plays embedded audio file or files (preferably compressed in industry standard format, e.g. .wav);
c) image web-page or pages displaying image or images (e.g. video-image or images from one or more cameras connected to corresponding personal-server either by cable(s) or wirelessly) preferably compressed in industry standard format (e.g. JPEG);
d) video web-page or pages displaying video or videos (e.g. video created from captured audio from microphone, line-in, etc. and tele-images from one or more cameras connected to corresponding personal-server either by cable(s) or wirelessly, captured video from streaming multimedia, etc.) that preferably after download auto-plays embedded video file or files (preferably compressed in industry standard format, e.g. avi, mpeg4) with or without audio;
e) talking-image web-page or pages:
   (i) displaying image or images (e.g. captured Windows PC window (e.g. active-window) image or images of opened image file, opened Microsoft Office document, website web-page, playing animation, playing multimedia, playing streaming multimedia, etc.) preferably compressed in industry standard format (e.g. JPEG); and
   (ii) preferably has hypertext-link(s) to said image file, said Microsoft Office document, website web-page, said animation, said multimedia, said streaming multimedia, etc. to allow (optionally) original image/document/animation/multimedia/streaming-multimedia/etc file(s) download and display by other meeting participants (to view and work with meeting contents: original images, original Microsoft Office document, original web-page, original animation, original streaming multimedia, etc., instead of being limited to viewing-only of captured Windows PC window image of said meeting contents); and said image file, said Microsoft Office document, said web-page, said animation, said multimedia, said streaming multimedia, etc. are automatically copied, if necessary, to the personal-server's wwwroot directory;
   (iii) preferably auto-plays embedded audio file or files (e.g. captured audio from microphone, line-in, or streaming multimedia, preferably compressed in industry standard format, e.g. .wav) after download; and
f) document (preferably in industry standard format, e.g. Microsoft Office document) file download web-page that meeting participant can click hypertext-link to download and that preferably Internet Explorer or custom software can open and display document after download.
g) animation, multimedia (e.g. video, slideshow, etc.) or streaming multimedia web-page that either auto-plays or user-click-to-play an embedded multimedia or streaming multimedia file (preferably in industry standard format, e.g. Windows media video .wmv format);
h) computer file download web-page that meeting participant can click hypertext-link to download a computer file (including zipped folder of computer files), save it, or optionally open it and display the said file on Internet explorer or custom software;
i) index, default, custom web-page, or URL or any web-page from any Internet web-site, which using hypertext-link allows meeting participant to surf a (meeting content) download's whole or partial website, or any said URL, web-page or website on the Internet.

In said My Shared File (referring to FIG. 5) of participant “A” above, it is noted that:
1. (In said My Shared File (referring to FIG. 5) of participant “A” above), said audio HTML or XML web-page or pages is preferably auto-updated by:
   i) saving periodically (e.g. every few seconds) the new update audio file or files (e.g. captured audio from microphone, line-in, streaming multimedia, etc.) to the corresponding personal-server's world wide web (typically called “wwwroot”) directory (or sub-directory, where the said audio web-page(s) or file(s) is located), and
   ii) (referring to FIG. 11) add to beginning of each new update audio file a duplicate copy of (fraction of a second) end of its preceding audio file to create a slight audio overlap between chronological audio files (to repair any broken syllable at the end of audio files), and
   iii) said audio web-page or pages download is preferably auto-refreshed by using HTML refresh computer code (or XMLHTTP object, or JavaScript code, etc.), and
   iv) auto-refresh time of each of the said audio web-page is auto-set to equal to or slightly longer than the audio play-time of each of the said audio web-page.
2. (In said My Shared File (referring to FIG. 5) of participant “A” above), said video HTML or XML web-page or pages is preferably auto-updated by:
   i) saving periodically (e.g. every few seconds) the new update video file or files (e.g. video created from captured audio from microphone and tele-images from camera(s) connected to corresponding personal-server either by cable(s) or wirelessly, captured video from streaming multimedia, etc.) to the corresponding personal-server's world wide web (typically called “wwwroot”) directory (or sub-directory, where said video web-page(s) or file(s) is located)
   ii) add at beginning of each new update video file a (fraction of a second) duplicate copy of (fraction of a second) end of its preceding video file to create a slight video overlap between chronological video files (to repair any broken syllable at the end of audio in the video files), and
   iii) said video web-page or pages download is preferably auto-refreshed by using HTML refresh computer code (or XMLHTTP object, or JavaScript code, etc.), and
   iv) auto-refresh time of the said video web-page is auto-set to equal to or slightly longer than the video play-time of the video web-page.
3. (In said My Shared File (referring to FIG. 5) of participant “A” above), said talking-image HTML or XML web-page or pages is preferably auto-updated by:
   i) saving periodically (e.g. every few seconds) the new update audio file or files to the corresponding personal-server's world wide web (typically called “wwwroot”) directory (or sub-directory, where said talking-image web-page(s) or file(s) is located), and
   ii) (referring to FIG. 11) add at beginning of each new update audio file a duplicate copy of (fraction of a second) end of its preceding audio file to create a slight overlap between chronological audio files (to repair any broken syllable at the end of audio files), and
   iii) saving periodically (e.g. every few seconds) the new update image file or files (e.g. captured Windows PC window (e.g. active-window) image or images from opened image file, opened Microsoft Office document, website web-page, playing animation, playing multimedia, playing streaming multimedia, etc.) to the same personal-server's world wide web (typically called “wwwroot”) directory (or sub-directory, where said talking-image page(s) or file(s) is located); and said image file, said Microsoft Office document, said web-page, said animation, said multimedia, said streaming multimedia, etc. are automatically copied (to update), if necessary, to the personal-server's wwwroot directory; and
   iv) updating periodically (e.g. every few seconds) the hypertext-link(s) to said image file, said Microsoft Office document, said web-page, said animation, said multimedia, said streaming multimedia, etc. to allow (optionally) original image/document/animation/multimedia/streaming-multimedia/etc file(s) download and display by other meeting participants (to view and work with meeting contents: original images, original Microsoft Office document, original web-page, original animation, original multimedia, original streaming multimedia, etc., instead of being limited to viewing-only of captured Windows PC window image of said meeting contents);
   v) said talking-image web-page or pages download is preferably auto-refreshed by using HTML refresh computer code (or XMLHTTP object, or JavaScript code, etc.), and
   vi) the auto-refresh time of each of said talking-image web-page is auto-set to equal to or slightly longer than the audio play-time of each of said talking-image web-page.
4. (In said My Shared File (referring to FIG. 5) of participant “A” above), said animation/multimedia/streaming-multimedia HTML or XML web-page or pages is preferably auto-updated by:
   i) saving periodically (e.g. every few seconds) the new update animation/multimedia/streaming-multimedia web-page or pages to the corresponding personal-server's world wide web (typically called “wwwroot”) directory (or sub-directory, where said animation/multimedia/streaming-multimedia page(s) or file(s) is located), and said animation/multimedia/streaming-multimedia web-page or pages download is preferably auto-refreshed (e.g. at intervals somewhat longer than the playtime of the animation/multimedia/streaming-multimedia) by using HTML refresh computer code (or XMLHTTP object, or JavaScript code, etc.); and
   ii) Participant may change its animation/multimedia/streaming-multimedia content for download by updating the animation/multimedia/streaming-multimedia URL address in the hypertext-link in said update animationlmultimedia/streaming-multimedia web-page or pages.
5. (In said My Shared File (referring to FIG. 5) of participant “A” above), said computer file download HTML or XML web-page or pages is preferably auto-updated by:
   i) saving periodically (e.g. every few seconds) the new update computer file download web-page to the corresponding personal-server's world wide web (typically called “wwwroot”) directory (or sub-directory, where said computer file download web-page(s) or file(s) is located), and said computer file download web-page or pages download is preferably auto-refreshed (e.g. every few seconds) by using HTML refresh computer code (or XMLHTTP object, or JavaScript code, etc.); and
   ii) Participant may change its computer file (including zipped folder of computer files) for download broadcast by having custom software to auto-update its computer file download URL address in the hypertext-link in said update computer file download web-page or pages, and auto-copying the changed computer file (including zipped folder of computer files) to the corresponding personal-server's world wide web (typically called “wwwroot”) directory (or sub-directory, where the previous computer file is located).
6. (In said My Shared File (referring to FIG. 5) of participant “A” above), said index, default, or other HTML or XML web-page or pages, or URL or any web-page from any Internet web-site, is preferably auto-updated by saving periodically (e.g. every few seconds) the new update index, default, or other web-page or pages, or URL or any web-page from any Internet web-site, to the corresponding personal-server's world wide web (typically called “wwwroot”) directory (or sub-directory, where said index, default, or other web-page(s) or file(s), or URL or any web-page from any Internet web-site, is located), and said index, default, or other web-page, etc. download may be preferably auto-refreshed (e.g. every few seconds) by using HTML refresh computer code (or XMLHTTP object, or JavaScript code, etc.).

Meeting participant “A” may optionally select answer/record selection (138 in FIG. 5) to use custom auto-answering/auto-recording software to perform:
a) Auto-answering (preferably with an audio/video/talking-images/multimedia introduction to instruct calling participant to leave an audio/video/talking-images/multimedia message) when participant “A” is off-line, and auto-recording the one-way audio/video/talking-images/multimedia meeting message(s) from calling participant(s) of point-to-point or multipoint meeting;
b) Auto-recording (when participant “A” is online) the two-way full-duplex-audio/video/talking-images/multimedia point-to-point or multipoint meeting.

If meeting participant “A” optionally select answer/record selection (138 in FIG. 5), custom auto-recording software on computer “K” may perform the following operation(s):
A. Audio recording(s) of its point-to-point or multipoint network meeting, and wherein by:
   saving after appending together (in their chronological order to form continuous audio recording(s)) said audio file downloads and said new update audio files download (in audio HTML or XML web-page(s) download and auto-updated audio web-pages download respectively), after removing the said duplicate copy of (fraction of a second) end of its preceding audio file download (that was added to the beginning of said each new update audio file download), in the same said compressed industry format (e.g. wav).
B. Record video recordings of its point-to-point or multipoint network meeting, and wherein by:
   i) saving said image file(s) download and said new update image files download (in image HTML or XML web-pages downloads and auto-updated image web-pages download respectively); and
   ii) duplicating said image file(s) download and said new update image file(s) download to create video (recording) frames as necessary for the play time (less the said fraction of a second audio overlap) of their corresponding embedded audio files; and
   iii) appending together (in their chronological order to form video recording(s) without audio) said image file(s) download and their duplicate copies and said new update image files download and their duplicate copies, in a compressed video industry format (e.g. avi); and
   iv) the saved audio recording (file(s)) from claim 10 and said saved video (without audio) recording (file(s)) can then be merged to form video (with audio) recording (file(s)) using industry format (e.g. avi); and
   v) the saving, duplicating, appending, and merging steps in B(i)-B(iv) above preferably is done real-time during the meeting.
C. Record video recording(s) of its point-to-point or multipoint network meeting, and wherein by:
   saving and appending together (in their chronological order to form video recording(s)) said video file(s) download and said new update video files download (in video HTML or XML web-page(s) download and auto-updated video web-pages download respectively), after removing the said duplicate copy of (fraction of a second) end of its preceding video file download (that was added to the beginning of said each new update video file download), in the same said compressed industry format (e.g. avi).
D. Record talking-image(s) (i.e. talking-slideshow) video recording(s) of its point-to-point or multipoint network meeting, and wherein by:
   i) saving said image file(s) download and said new update image files download (in talking-image HTML or XML web-page(s) download and auto-updated talking-image web-pages download respectively); and
   ii) duplicating said image files download and said new update image files download to create video (recording) frames as necessary for the play time (less the said fraction of a second audio overlap) of their corresponding embedded audio files; and
   iii) appending together (in their chronological order to form video recording(s) without audio) said image file(s) download and their duplicate copies and said new update image files download and their duplicate copies, in a compressed video industry format (e.g. avi); and
   iv) saving after appending together (in their chronological order to form continuous audio recording(s)) said audio file(s) download and said new update audio files download (in talking-image web-page(s) download and auto-updated talking-image web-pages download respectively), after removing the said duplicate copy of (fraction of a second) end of its preceding audio file download (that was added to the beginning of said each new update audio file download), in the same said compressed industry format (e.g. wav); and
   v) the said video (without audio) recording (file(s)) from (iii) and said audio recording (file(s)) from (iv) can then be merged to form one video (with audio) recording (file) using industry format (e.g. .avi); and
   vi) the saving image, duplicating, appending, saving audio, and merging steps in D(i)-D(v) above is preferably done real-time during the meeting.

The meeting participant “A” may click to create or update (37) the My Shared File (meeting content download “T”) record (according to CGI script 58 in FIG. 8) for the server database 28 to store the latest information (My Shared File name, URL address, broadcast type, password, permitted meeting participants, and other pertinent information). When created, the said My Shared File information record is added to a My Shared File (i.e. meeting content download, referring to FIG. 9) list containing the My Shared File (i.e. meeting content download) information records of downloads in various personal-servers “T”. This said My Shared File (meeting content download) list is automatically updated (according to CGI script 58 in FIG. 8) to reflect current information (My Shared File name, URL address, broadcast type, password, permitted meeting participants, and other pertinent information) of My Shared File (meeting content download) in various personal-server “T”, so that if a My Shared File (meeting content download “T”) of a personal-server “T” is online, meeting participants may seek to download it freely if it is a public My Shared File (meeting content download “T”), or may seek permission from the said My Shared File (meeting content download “T”) personal-server “T” and/or enter a password required if it's a private My Shared File (meeting content download “T”). (The terminology for My Shared File (meeting content download “T”) then becomes other meeting participants' sought meeting content download “T”.)

If interested to seek My Shared File (meeting content download) from various personal-servers to download, referring back to FIG. 4, the meeting participant “A” may click the sought (meeting content) download (33) selection to display a form (refer to FIGS. 7A and 7B) to review current sought (meeting content) download status (online, offline, 1-way-auto-download, 2-way-auto-download (in FIG. 7A) or N-way-auto-download (in FIG. 7B), waiting permission, or permission denied), or to delete its sought (meeting content) download entry, or to add sought (meeting content) download (by entering sought download name and password if required by sought download).

In FIG. 7A, the meeting participant “A” may:
a) click (44 in FIG. 7A) online sought (meeting content) download “X” (which has hypertext-link to the URL address of the sought download “X”) to download and view the clicked online sought (meeting content, typically a HTML or XML web-page) download “X” on web browser “K” (refer to FIG. 8); and
b) optionally specify 1-way-auto-download (to establish 1-way meeting), so that the connection routine of sought download's personal-server “X” (or computer “L”) will immediately notify the computer “K” (of meeting participant “A”) to download sought download “X” (whenever seeking participant “A” becomes connected); or
c) optionally specify 2-way-auto-download (to establish point-to-point 2-way meeting), so that its computer connection routine 30 will immediately notify the clicked sought download's computer “L” to call-back and download My Shared File (meeting content download) of participant “A” (from personal-server “T”), thus creating 2-way (meeting content) download (and effectively making 2-way connection for 2-way network meeting) between participant “A” and participant “B”; or
d) click to create or update (40 in FIG. 7A) its sought (meeting content) download record (according to CGI script 58, referring to FIG. 8) to store the latest information (sought download names, passwords required, etc.) in server database 28.

In FIG. 7B, the meeting participant “A” may:
1) click (44's in FIG. 7B) online sought (meeting content) downloads “X”, “Y”, and “Z” (which have hypertext-links to the URL addresses of the sought downloads “X”, “Y”, and “Z” respectively) to download and view the clicked online sought (meeting content, typically a HTML or XML web-page) downloads “X”, “Y”, and “Z” on (three) web browsers “K” (refer to FIG. 8); and
2) specify N-way-auto-downloads for “X”, “Y”, and “Z” (to establish multipoint peer-to-peer 2-way meeting) so that both of the following happens:
   a) call-back auto-download: computers “L”, “M”, “N” (used by participants “B”, “C”, “D” respectively) will promptly call-back personal-server “T” (used by participant “A”) to auto-download the (meeting content) download “T”, after computers “L”, “M”, “N” receive the URL address of (meeting content) download “T” (from connection routine 30 of computer “K” used by “A”).
   b) call-around auto-download (by computers “L”, “M”, “N”):
      i) Computer “L” call-around to download from “Y” and “Z”, after computer “L” receives the URL addresses of downloads “Y” and “Z” (from connection routine 30 of computer “K” used by “A”);
      ii) Computer “M” call-around to download from “X” and “Z”, after computer “M” receives the URL addresses of downloads “X” and “Z” (from connection routine 30 of computer “K” used by “A”);
      iii) Computer “N” call-around to download from “Y” and “Z”, after computer “N” receives the URL addresses of downloads “X” and “Y” (from connection routine 30 of computer “K” used by
3) click to create or update (40 in FIG. 7B) its sought (meeting content) download record (according to CGI script 58, referring to FIG. 8) to store the latest information (sought download names, passwords required, etc.) in server database 28.

When created (40 in FIGS. 7A and 7B), the said sought (meeting content) download record of meeting participant “A” is added into a sought (meeting content) download list containing the information records of sought (meeting content) downloads of various meeting participants. When updating (40 in FIGS. 7A and 7B), the latest information (delete sought download, add sought download, password, and other pertinent information) updates the sought (meeting content) download record of meeting participant “A” in the said sought (meeting content) download list. If a sought (meeting content) download has denied permission status, it'll be removed automatically (according to CGI script 58 in FIG. 8) during the update (after review by meeting participant “A”).

Having now described the process via one implementation of the present invention, the underlying techniques are now described. FIG. 8 illustrates the basic architecture for the World-Wide Web interface for one embodiment. Meeting participant “A” activates a web browser “K” (or custom software including instant messaging software) on computer “K” (referring to FIG. 2A), and connects to the interconnected network 14, e.g. Internet, via the web browser “K”. By visiting a site such as database-server 20 in our example “http://www.databaseserver.com”, a file in the hypertext mark-up language (HTML) format is sent to the meeting participant “A” and displayed by the web browser “K” on the meeting participant's computer “K” which preferably has a personal-server “T” installed. In certain cases, a form (for an example, refer to FIG. 4) requesting information from the meeting participant “A” is sent to the meeting participant “A” in HTML or XML format. If custom software “T” (e.g. custom instant messaging or network-meeting software) is used, a custom (user interface) dialog-screen can be used (in lieu of HTML or XML form file) to request information from the meeting participant “A”. By completing the form and sending it back to the database-server 20, a designated common gateway interface (CGI) script 58 (which typically is a series of commands in the PERL programming language) may be programmed to be executed by the database-server 20.

If meeting participant “A” clicks sought download selection (33 in example FIG. 4), the commands in the script file would request the database-server 20 to send a hypertext link for the URL address of the meeting participant's permitted online sought (meeting content) download “X” to the meeting participant's web browser “K”, which the meeting participant “A” may click (the hypertext link of the URL address) to download its sought (meeting content) download “X” from other meeting participant's personal-server “X” (referring FIG. 3A and FIG. 8).

Similarly, meeting participant “B” may click its hypertext link for URL address of My Shared File (meeting content download “T”) of meeting participant “A” to download the meeting participant's My Shared File (meeting content download “T”) from personal-server “T”. (The terminology for My Shared File (meeting content download “T”) then becomes other meeting participant's sought (meeting content) download “T”.)

FIG. 9 illustrates an overall user interface (e.g. web-page) flow structure (corresponding to FIGS. 4-7) of an implementation of one embodiment of the present invention. The user interface (e.g. web-page) flow structure is briefly described and the major functions such as the create/update My Shared File function and the create/update sought download function are described in detail in the following sections. When visiting the database-server 20 on the Internet, the database-server 20 sends to the meeting participant “A” the Database-Server Log-in HTML or XML file 70 which provides meeting participant “A” log-in, and three hypertext selections (FIG. 4). By clicking on a selection, the log-in and corresponding CGI script files may be executed and the corresponding form HTML or XML file 31-34 is sent to meeting participant “A”.

From the My Shared File (meeting content download “T”) HTML or XML web-page 31 (referring to FIG. 5 and FIG. 9), the meeting participant “A” may complete the My Shared File form, and select the create My Shared File selection 37 whereby the corresponding CGI script 58 (FIG. 8) is executed, a new My Shared File record is created and added to the My Shared File list (37 in FIG. 9). Meeting participant “A” also may select permitted meeting participants (35 in FIG. 5) selection to permit other meeting participants to download its My Shared File (meeting content download “T”) from the personal-server “T”. The list of permitted meeting participants is displayed (FIG. 6, and 35 in FIG. 9) to meeting participant “A”, and meeting participant “A” may add or delete other meeting participants, or change meeting participant permission. Meeting participant “A” click selection 38 to create or update the permitted meeting participants information and the underlying permitted meeting participants CGI script is executed (38 in FIG. 9) to update the corresponding permitted meeting participants record and list in server database 28.

Under the sought (meeting content) download page 33 (FIGS. 7A and 7B), the current sought (meeting content) download status is retrieved (from server database 28, using corresponding CGI script 58 in FIG. 8) and displayed on the sought (meeting content) download HTML or XML form page (FIGS. 7A and 7B) which is displayed on web browser “K” for review by meeting participant “A”. The meeting participant “A” may click online sought (meeting content) download “X” (which has hypertext-link to the URL address of the sought download “X”) to download and view the clicked online sought (meeting content, typically a HTML or XML web-page) download “X” on a web browser “K”. The meeting participant “A” may also complete the sought (meeting content) download form, and select the create/update sought download selection (40 in FIG. 7A, FIG. 7B and FIG. 9) whereby the corresponding CGI script file (58 in FIG. 8) is executed, the sought (meeting content) download record is created/updated, and the sought (meeting content) download list is updated.

From the public download page 34, (optionally) randomly selected online public (meeting content) downloads are retrieved on the public (meeting content) download form (accordingly to corresponding CGI script 58 in FIG. 8). The meeting participant “A” may also search for any public (meeting content) download in the (meeting content) download list (stored in server database 28) based on various search criteria, e.g. download names which match a search string of characters, etc.

FIG. 10A illustrates an alternative or in-addition to the above preferred embodiment of the present invention, wherein the participant “AA” downloads the sought (meeting content) download “X” of FIG. 2B, by clicking instant message (which has hypertext-link to the URL address of the sought download “X”) from “BB”, and wherein both participants “AA” and “BB” being connected and exchanging messages using instant messaging software from Microsoft, AOL, ICQ, Yahoo!, etc.

FIG. 10B illustrates an alterative or in-addition to the above preferred embodiment of the present invention, is an extension of FIG. 10A, wherein the participants “AA” and “BB” download the sought (meeting content) downloads “X” and “T”, by clicking instant messages (which has hypertext-links to the URL address of the sought downloads “X” and “T”) from “BB” and “AA” respectively, and wherein both participants “AA” and “BB” being connected and exchanging messages using instant messaging software from Microsoft, AOL, ICQ, Yahoo!, etc.

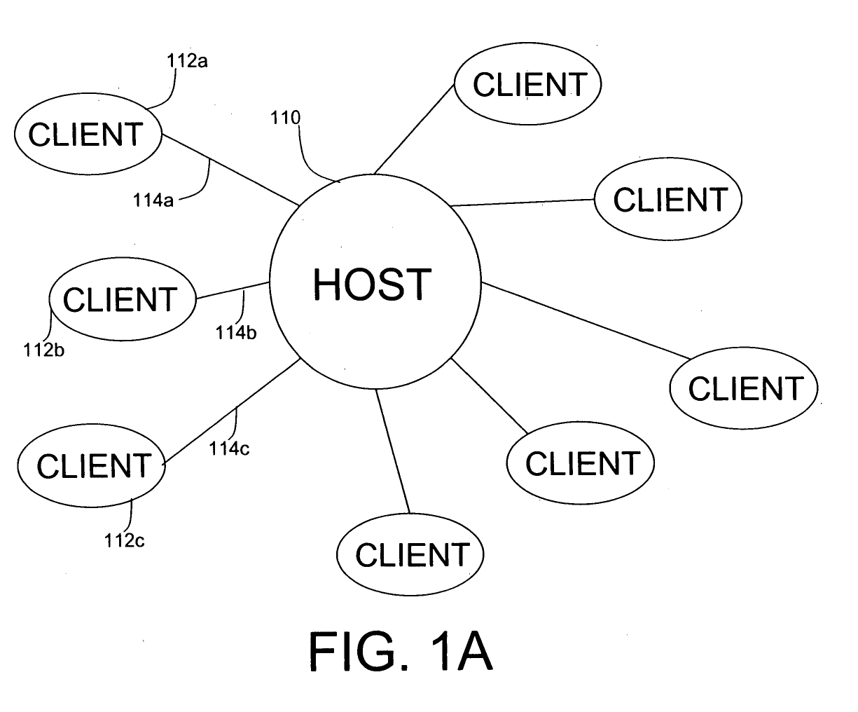

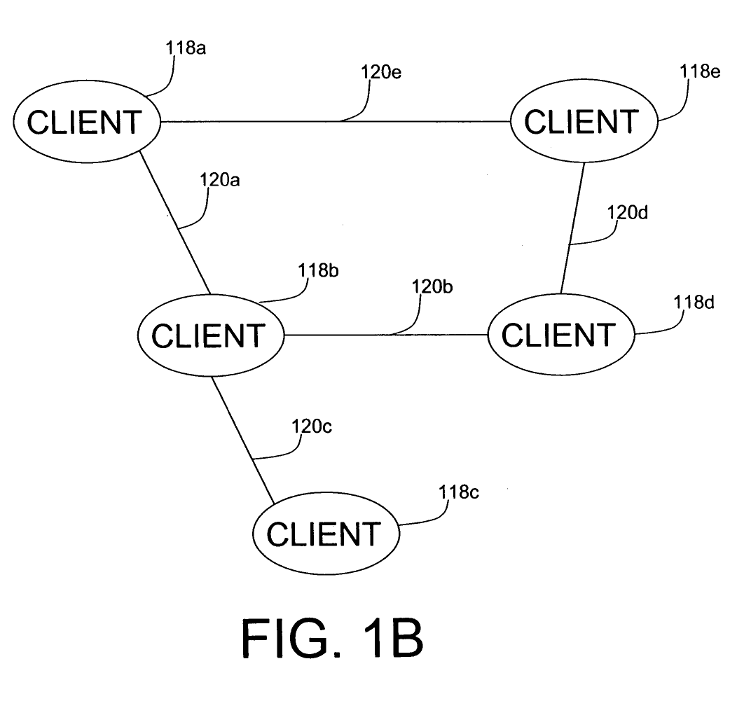

FIG. 1 ° C. illustrates an alternative or in-addition to above embodiment of the present invention, is an extension of FIG. 10B, and participants “AA”, “BB”, “CC” and “DD” are connected and exchanges messages using instant messaging software from Microsoft, AOL, ICQ, Yahoo!, etc., and wherein:
Part 1: Setup sought (meeting content) download “T” for participants “BB”, “CC” and “DD”:
   a) connection routine 30 (of personal-server “T”) optionally creates text-message with hypertext-link to the URL address of the sought download “T” and saves said text-message in clip-board.
   b) participant “AA” sends the said clip-board text-message as instant message to participants “BB”, “CC” and “DD” (by using Control_V, i.e. pressing the two keys “Control” and “V” simultaneously, to paste the said clip-board text-message onto its instant message dialog-box and then click “send” to send the instant message to other three participants).
   c) participants “BB”, “CC” and “DD” receive said instant messages from user “CC” and click said hypertext-link (to the URL address of the sought download “T”) to download the sought download “T”;
Part 2: Setup sought (meeting content) download “X” for participants “AA”, “CC” and “DD” (similar to that in Part 1);
Part 3: Setup sought (meeting content) download “Y” for participants “AA”, “BB” and “DD” (similar to that in Part 1);
Part 4: Setup sought (meeting content) download “Z” for participants “BB”, “CC” and “DD” (similar to that in Part 1); resulting in multipoint peer-to-peer 2-way meeting.

FIG. 11 illustrates adding to a beginning of each new update audio file a duplicate copy of (fraction of a second) end of its preceding audio file to create a slight audio overlap between chronological audio files (to repair any broken syllable at the end of audio files).

FIG. 12A is a simplified pictorial illustration of a network meeting system constructed and operative in accordance with one embodiment of the present invention, wherein:
i. Meeting participant “A” uses edit routine 68 on “K” to open and optionally edit a file on computer “K” or an URL on interconnected network 14, thereby designating it as (meeting content) download “T”.
ii. Edit routine 68 on “K” (preferably periodically, e.g. every few seconds) copies said file or URL to wwwroot of “T” as (meeting content) download “T” and
iii. Edit routine 68 on “K” (preferably periodically, e.g. every few seconds) creates the necessary web-page with hyperlinks for the (meeting content) download (by seeking meeting participants) and save it to said wwwroot directory.

FIG. 12B is a simplified pictorial illustration of a network meeting system constructed and operative in accordance with one embodiment of the present invention, is continuation of FIG. 12A, wherein:
i. Seeking meeting participant “B” of FIG. 12A uses edit routine 68 on “L” to download, view and optionally edit (another meeting participant A's meeting content) download “T”.
ii Edit routine 68 on “L” (preferably periodically, e.g. every few seconds) copies said (possibly edited) downloads to wwwroot of “X” as (meeting content) download “X”.
iii. Edit routine 68 on “L” (preferably periodically, e.g. every few seconds) creates the necessary web-page with hyperlinks for the (meeting content) download (by other seeking meeting participants) and save it to said wwwroot directory.

FIG. 12C is a simplified pictorial illustration of a network meeting system constructed and operative in accordance with one embodiment of the present invention, is continuation of FIG. 12B, wherein:
i. Meeting participant “A” of FIG. 12B uses edit routine 68 on “K” to download the (possibly edited-by-B meeting content) download “X” of FIG. 12B.
ii. Edit routine 68 on “K” (preferably periodically, e.g. every few seconds) copies said download to update (A's meeting content) download “T” for viewing by “B”, “C”, and “D”.
iii. Edit routine 68 on “K” (preferably periodically, e.g. every few seconds) updates the web-page for the updated (meeting content) download “T”.

FIG. 12D is a simplified pictorial illustration of a network meeting system constructed and operative in accordance with one embodiment of the present invention, is alternate-to or in-addition-to FIG. 12C, and is a continuation of FIG. 12B, wherein:
i. “B” uses edit routine 68 on “L” to click hypertext-linked download to download from “T” and request edit control from “K”.
ii. Edit routine 68 on “L” obtain edit control from “K”.
iii. “B” uses edit routine 68 on “L” to edit (said download from “T”).
iv. Edit routine 68 on “L” (preferably periodically, e.g. every few seconds) saves (possibly edited) download-from-T to wwwroot of “X” (now called download “X”), and updates the web-page for download “X”.
v. Edit routine 68 on “K” (preferably periodically, e.g. every few seconds) downloads from “X” to update A's (meeting content) download in wwwroot of “T” (for viewing by “B”, “C”, and “D”).
vi. When “B” finishes editing, edit routine 68 on “L” releases edit control back to

FIG. 13A is a simplified pictorial illustration of a network meeting system constructed and operative in accordance with one embodiment of the present invention, wherein:
i. Meeting participant “A” uses edit routine 68 on “K” to start an application to open and optionally edit a file on computer “K” or an URL on interconnected network 14, thereby designating it as (meeting content) download “T”,
ii. Edit routine 68 on “K” (preferably periodically, e.g. every few seconds) captures Windows image of said application, and copies said image and said file or said URL to wwwroot of “T” as (meeting content) download “T”.
iii. Edit routine 68 on “K” (preferably periodically, e.g. every few seconds) creates the necessary web-page with hyperlinks for the (meeting content) download (by seeking meeting participants) and save it to wwwroot directory of “T”.

FIG. 13B is a simplified pictorial illustration of a network meeting system constructed and operative in accordance with one embodiment of the present invention, is continuation of FIG. 13A, wherein
i. Seeking meeting participant “B” of FIG. 13A uses edit routine 68 on “L” to click hypertext-link to download (meeting participant A's meeting content) and to pop-up copy of application (on “L” or interconnected network 14) and to view and optionally edit said download (in the said application).
ii. Edit routine 68 on “L” (preferably periodically, e.g. every few seconds) captures Windows image of said application, and copies said image and said (possibly edited-by-B) download to wwwroot of “X” as (meeting content) download “X”.
iii. Edit routine 68 on “L” (preferably periodically, e.g. every few seconds) create the necessary web-page with hyperlinks for the (meeting content) download (by other seeking meeting participants) and save it to wwwroot directory of “X”.

FIG. 13C is a simplified pictorial illustration of a network meeting system constructed and operative in accordance with one embodiment of the present invention, is continuation of FIG. 13B, wherein:
i. Meeting participant “A” of FIG. 13B uses edit routine 68 on “K” to operate application (started in FIG. 13A) and to download the (possibly edited-by-B meeting content) download “X” of FIG. 13B.
ii. Edit routine 68 on “K” (preferably periodically, e.g. every few seconds) captures Windows image of said application, and copies said image and said download to update (A's meeting content) download “T” for viewing by “B”, “4C”, and “D”.
iii. Edit routine 68 on “K” (preferably periodically, e.g. every few seconds) updates the web-page for the updated (meeting content) download “T”.

FIG. 13D is a simplified pictorial illustration of a network meeting system constructed and operative in accordance with one embodiment of the present invention, is alternate-to or in-addition-to FIG. 13C, and is a continuation of FIG. 13B, wherein:
i. “B” uses edit routine 68 on “L” to click hypertext-link to download from “T” and to pop-up copy of application on “L”.
ii. Edit routine 68 on “L” requests and obtains application and edit control from
iii. “B” optionally uses edit routine 68 on “L” (to operate application on “L”) to edit said download from “T”.
iv. Edit routine 68 on “L” (preferably periodically, e.g. every few seconds) captures Windows image of said application, and copies said image and said (possibly edited-by-B) download to wwwroot of “X” as (meeting content) download “X”.
v. Edit routine 68 on “L” (preferably periodically, e.g. every few seconds) create the necessary web-page with hyperlinks for the (meeting content) download (by other seeking meeting participants) and save it to wwwroot directory of “X”.
vi. Edit routine 68 on “L” (preferably periodically, e.g. every few seconds) captures Windows image of application (on “L”), and copies said image and said (possibly edited-by-B) download to wwwroot of “X”.
vii. Edit routine 68 on “K” changes refresh-IP-address (of application image and download) from “T” to “X”.
viii. When refreshed, web-pages (of application image and download) in wwwroot of “T”, uses X's IP address to jump to “X”, so that other seeking participants (e.g. “A”, “C”, “D”) will now be downloading from “X” (when web-pages are refreshed).
ix. “A” (or “C” or “D”) may go through steps i-vi to take application and edit control from “B”.

It should be noted that as an alternative or in-addition-to edit routines 68 on “K” and “L” periodically (e.g. every few seconds) capturing Windows image of said application, well-known motion-detection technique (applied to detect any changes in the applications window) can be used to promptly update the captured application image, etc. in the wwwroot of “T” and “X” respectively (so that the updates do not need to wait until the extra few seconds before the next periodic capture/refresh).

Creating My Shared File (meeting content download) in meeting participant's personal-server “T”: Referring to FIG. 4, the My Shared File selection 31 provides the meeting participant “A” with the My Shared File form 31 (FIG. 5) sent by the database-server 20 to the meeting participant's web browser “K”. The form provides blank spaces requesting My Shared File information from the meeting participant “A”, information such as the My Shared File name (which by default is same as the meeting participant name), password (if needed for other meeting participants to download and view My Shared File (meeting content download “T”)), IP address (of the meeting participant's personal-server “T”), file name (of My Shared File (meeting content download “T”)), broadcast type, etc. The meeting participant “A” may browse its personal-server “T” WWW (world wide web) root directory for its My Shared File (meeting content download “T”) file. The meeting participant “A” may enter its personal-server's IP address, or preferably address routine 26 (on computer “K” or personal-server “T”) uses Microsoft Winsock API (applications interface) to extract IP address from HOSTENT structure as described previously; alternatively or additionally, the IP address may also be obtained from the CGI environment variable REMOTE.sub-ADDR (using database-server 20 CGI script 58, referring to FIG. 8). The meeting participant's personal-server IP address (e.g. IP1.IP2.IP3.IP4) and My Shared File name (e.g. MyBroadCastFileName.htm) is concatenated together to form the URL address (e.g. http://IP1.IP2.IP3.IP4/MyShared FileName.htm) of My Shared File which allows download and display on web browser of the meeting participant's My Shared File (meeting content download “T”) over the interconnected network 14, e.g. Internet.

If My Shared File type is private, the meeting participant “A” may enter password required for its My Shared File download, or select permitted meeting participants (35 on FIG. 5) selection to add, delete, review meeting participant names permitted (refer to FIG. 6) to download its My Shared File. The meeting participant “A” may then click to create or update (37 in FIG. 5) the My Shared File record (according to CGI script 58 in FIG. 8) to store the latest information (My Shared File name, URL address, broadcast type, password, permitted meeting participants, and other pertinent information) in server database 28. When created, the said My Shared File record is added to the My Shared File list (in server database 28) containing the records for My Shared File (meeting content download) in various personal-servers. This said My Shared File list (in server database 28) is automatically updated (according to corresponding CGI script 58 in FIG. 8) to reflect current information (My Shared File name, URL address, broadcast type, password, permitted meeting participants, and other pertinent information) of My Shared File (meeting content download) from various personal-servers, so that if a My Shared File (meeting content download) of a personal-server is online, meeting participants may seek to download it freely if it is a public My Shared File (meeting content download), or may seek permission from the said My Shared File (meeting content download) personal-server and/or enter a password if it's a private My Shared File. (The terminology for My Shared File (meeting content download) then becomes other meeting participant's sought (meeting content) download.)

Sought (meeting content) downloads (over the Internet) from other meeting participant's personal-servers: If interested to seek (meeting content) download from other personal-server “X”, referring back to FIG. 4, the meeting participant “A” may click the sought (meeting content) download (33) selection to display a form (FIGS. 7A and 7B) to review current sought (meeting content) download status (online, offline, waiting permission, or permission denied), or delete its sought download entry, or add sought download (by entering sought download name and password if required by sought download personal-server “X”).

In FIG. 7A, the meeting participant “A” may:
a) click (44 in FIG. 7A) online sought (meeting content) download “X” (which has hypertext-link to the URL address of the sought download “X”) to download and view the clicked online sought (meeting content, typically a HTML or XML web-page) download “X” on web browser “K” (refer to FIG. 8); and
b) optionally specify 1-way-auto-download (to establish 1-way meeting), so that the connection routine of sought download's personal-server “X” (or computer “L”) will immediately notify the computer “K” (of meeting participant “A”) to download sought download “X” (whenever seeking participant “A” becomes connected); or
c) optionally specify 2-way-auto-download (to establish point-to-point 2-way meeting), so that its computer connection routine 30 will immediately notify the clicked sought download's computer “L” to call-back and download My Shared File (meeting content download) of participant “A” (from personal-server “T”), thus creating 2-way (meeting content) download (and effectively making 2-way connection for 2-way network meeting) between participant “A” and participant “B”; or
d) click to create or update (40 in FIG. 7A) its sought (meeting content) download record (according to CGI script 58, referring to FIG. 8) to store the latest information (sought download names, passwords required, etc.) in server database 28.

In FIG. 7B, the meeting participant “A” may:
1) click (44's in FIG. 7B) online sought (meeting content) downloads “X”, “Y”, and “Z” (which have hypertext-links to the URL addresses of the sought downloads “X”, “Y”, and “Z” respectively) to download and view the clicked online sought (meeting content, typically a HTML or XML web-page) downloads “X”, “Y”, and “Z” on (three) web browsers “K” (refer to FIG. 8); and
2) specify N-way-auto-downloads for “X”, “Y”, and “Z” (to establish multipoint peer-to-peer 2-way meeting) so that both of the following happens:
   a) call-back auto-download: computers “L”, “M”, “N” (used by participants “B”, “C”, “D” respectively) will promptly call-back personal-server “T” (used by participant “A”) to auto-download the (meeting content) download “T”, after computers “L”, “M”, “N” receive the URL address of (meeting content) download “T” (from connection routine 30 of computer “K” used by “A”).
   b) call-around auto-download (by computers “L”, “M”, “N”):
      i) Computer “L” call-around to download from “Y” and “Z”, after computer “L” receives the URL addresses of downloads “Y” and “Z” (from connection routine 30 of computer “K” used by “A”);
      ii) Computer “M” call-around to download from “X” and “Z”, after computer “M” receives the URL addresses of downloads “X” and “Z” (from connection routine 30 of computer “K” used by “A”);
      iii) Computer “N” call-around to download from “Y” and “Z”, after computer “N” receives the URL addresses of downloads “X” and “Y” (from connection routine 30 of computer “K” used by “4A”);
3) click to create or update (40 in FIG. 7B) its sought (meeting content) download record (according to CGI script 58, referring to FIG. 8) to store the latest information (sought download names, passwords required, etc.) in server database 28.

When created (40 in FIGS. 7A and 7B), the said sought (meeting content) download record of said meeting participant “A” is added to a sought (meeting content) download list containing the information records of sought (meeting content) downloads of various meeting participants. When updating (40 in FIGS. 7A and 7B), the latest information (delete sought download, add sought download, password, and other pertinent information) updates the sought (meeting content) download record of said meeting participant “A” in the said sought (meeting content) download list in server database 28. If a sought (meeting content) download has denied permission status, it'll be removed automatically (according to CGI script 58 in FIG. 8) during the update (after review by meeting participant “A”).

Once the sought (meeting) download session is established, there is no traffic (data packets) going through the database-server 20. The meeting participants download and view the sought (meeting content) download on a web browser (or custom software) directly from the sought (meeting content) downloads' respective personal-servers over the interconnected network 14, e.g. Internet.

If the sought (meeting content) download is off-line (e.g. Boss Meeting, referring to FIGS. 7A and 7B), participant “A” may leave an audio/video/talking-images/multimedia message by:
a) Specifying 2-way-auto-download (FIG. 7A) or N-way-auto-download (FIG. 7B); and
b) Click the selected sought offline (meeting content) download (e.g. Boss Meeting in FIGS. 7A and 7B), so that its computer connection routine 30 (of computer “K”) will immediately notify the clicked sought offline download's computer (of Boss Meeting) to call-back and download My Shared File (meeting content download) of participant “A” (from personal-server “T”); and
c) If Boss Meeting have selected answer/record selection (138 in FIG. 5) in (its Boss Meeting My Shared File), the custom auto-answering/auto-recording software of computer (or personal-server) of Boss Meeting will auto-answer (preferably with an audio/video/multimedia introduction to instruct calling participant “A” to leave an audio/video/talking-images/multimedia message), and auto-record (using custom auto-recording software described in detail above) the one-way audio/video/talking-images/multimedia meeting message(s) from calling participant “A” of the point-to-point or multipoint meeting.

Removing the My Shared File (meeting content download “T”) from the meeting participant's personal-server “T”: The meeting participant “A” may remove its My Shared File (meeting content download “T”) via blanking-out the My Shared File name (refer to FIG. 5) and un-authorizing (or deleting) all meeting participants from its permitted participant form (refer to FIG. 6). (The address routine 26 may also insert a random number or a string of random printable characters into the My Shared File name in the meeting participant's personal-server “T” wwwroot directory, so that each time a My Shared File is created/updated, it has a new My Shared File name and a new URL address to increase security, as described above.) The meeting participant's My Shared File (meeting content download “T”) name will be deleted from the (meeting content) download list by a CGI script 58 in FIG. 8. This process can also be automated where the personal-server connection update routine 30 periodically notify the network database-server 20 to update/remove My Shared File (meeting content download) information in the (meeting content) download list (in server database 28) accordingly.

Answering Machine: The meeting participant “A” may optionally specify answer/record operation (138 in FIG. 5) to auto-answer (preferably with an audio/video/multimedia introduction to instruct calling participant(s) to leave an audio/video/talking-images/multimedia message) when it is off-line, and auto-record (using custom auto-recording software described in detail above) the one-way audio/video/talking-images/multimedia meeting message(s) from calling participant(s) of the point-to-point or multipoint meeting.

To establish one-way meeting (refer to FIG. 3A), the meeting participant “A” selects an online (meeting content) download “X” (refer to FIG. 7A), and clicks the latter (which has hypertext-link to URL address of said meeting content download “X”) to download and preferably auto-refresh the selected auto-updated (meeting content) download (e.g. auto-refreshed and auto-updated meeting contents such as audio and video-images HTML or XML web-pages, talking-image web-page, etc.) without the participant “A” having to know the URL addresses of the latter.

Alternatively or in addition, to establish one-way meeting (referring to FIG. 7A), participant “A” may optionally specify 1-way-auto-download, so that the connection routine of sought download's personal-server “X” (or computer “L”) will immediately notify the computer “K” (of meeting participant “A”) to download sought download “X” (whenever seeking participant “A” becomes connected).

To establish two-way meeting (refer to FIG. 3B), preferably seeking participant specify 2-way-auto-download (refer to FIG. 7A), so that seeking participant's computer “K” will immediately notify selected sought download personal-server “X” (or computer “L”) to call-back and download seeking participant's meeting content download “T” (from its personal-server “T”).

Once the one-way or two-way or multipoint meeting is established, no data goes through database-server 20. Meeting content downloads “T” and “X” (e.g. auto-updated audio and video-image HTML or XML web-pages, talking-image web-page, etc.) are directly downloaded by the respective web browsers “K” and “L” (or custom software) of meeting participants “A” and “B”.

To establish multipoint peer-to-peer two-way meeting (refer to FIG. 3C), preferably seeking participant specify N-way auto-downloads (refer to FIG. 7B), so that after seeking participant “A” clicks to download (meeting content) downloads “X”, “Y”, “Z”, seeking participant's computer “K” will immediately notify selected sought downloads' personal-servers X, Y, Z (or computers “L”, “M”, “N”) to:
a) call-back auto-download: computers “L”, “M”, “N” (used by participants “B”, “C”, “D” respectively) will promptly call-back personal-server “T” (used by participant “A”) to auto-download the (meeting content) download “T”, after computers “L”, “M”, “N” receive the URL address of (meeting content) download “T” (from connection routine 30 of computer “K” used by “A”).
b) call-around auto-download (by computers “L”, “M”, “N”):
   i) Computer “L” call-around to download from “Y” and “Z”, after computer “L” receives the URL addresses of downloads “Y” and “Z” (from connection routine 30 of computer “K” used by “A”);
   ii) Computer “M” call-around to download from “X” and “Z”, after computer “M” receives the URL addresses of downloads “X” and “Z” (from connection routine 30 of computer “K” used by “A”);
   iii) Computer “N” call-around to download from “Y” and “Z”, after computer “N” receives the URL addresses of downloads “X” and “Y” (from connection routine 30 of computer “K” used by “A”).

Once the multipoint peer-to-peer two-way meeting is established, no data goes through database-server 20. Meeting content downloads “T”, “X”, “Y”, and “Z” (e.g. auto-updated audio and video-image HTML or XML web-pages, talking-image web-page, etc.) are directly downloaded by the respective web browsers “K”, “L”, “M”, and “N” (or custom software) of meeting participants “A”, “B”, “C”, and “D”.

Note that in the case where a network has a firewall and there is a SOCKS proxy running between the browser(s) “T”, etc. and the database-server 20, the CGI script 58 gets the IP address of the SOCKS proxy rather than the IP address of the computer(s) “K”, etc. that is running the browser(s) “T”, etc. This problem is solved by providing a name registration daemon that registers each meeting participant's (i.e. computer(s) “K”, etc.) IP address and port number. When the computer (s) “K”, etc. or personal-server(s) “T”, etc. launches address routine 26 (and web browser(s) “T”, etc. or custom software), the said address routine 26 first makes a TCP/IP connection to the name registration daemon so that the daemon registers the IP address of computer(s) “K”, etc. or personal-server(s) “T”, etc.

Recording Meeting: The meeting participant “A” may optionally select answer/record (138 in FIG. 5) to specify recording-meeting operation (when it is online) and auto-record (using custom auto-recording software described in detail above) the two-way full-duplex-audio/video/talking-images/multimedia point-to-point or multipoint meeting.

It is appreciated that any of the software components of the present invention may, if desired, be implemented in ROM (read-only memory) form. The software components may, generally, be implemented in hardware, if desired, using conventional techniques.

In one embodiment of the invention described with reference to the flow chart of FIG. 14, in process 1400, the computer K automatically captures a first screen shot of an active application. As used here in the term “screen shot” denotes data pertaining to the active application, which data is currently being displayed on a computer screen of the computer K. In process 1402, the computer K saves the first screen shot in a directory from which a server attempts to retrieve downloadable files for a network. For example, the directory may be a well-known directory or a default directory such as the WWWroot directory for an HTTP server. In some embodiments, the directory may be a local directory in the computer K, or it may be a remote directory of another computer/server. In process 1404, the computer K automatically generates a code to create a web page. The code contains a reference to the first screen shot. In one embodiment the code may comprise HTML or XML code which can be executed by a browser to render the first screen shot. In process 1406, the computer K publishes the web page. In one embodiment, publishing the web page may comprise sending an instant message containing a link to the web page to another computer.

In process 1408, the computer K a) automatically captures a second screen shot of the active application at a later time; b) saves the second screen shot in the directory; c) updates the code to create a web page to contain reference to the second screen shot. The steps a), b), c) of process 1408 may be performed periodically, in one embodiment.

In one embodiment, saving the second screen shot may be performed by overwriting the first screen shot. In one embodiment, the first and second screen shots may comprise original data and presentation information, for example, in the form of a template to control the presentation of the original data when it is rendered or presented on a computer screen.

In some embodiments, the first and second screen shots may comprise screen shots of a file being viewed using the active application, for example, the file may be a streaming media file. In some cases, the file may comprise a file stored in a database.

In one embodiment, the first and second screen shots may comprise user modifications to the file being viewed using the active application. For example, the file may be a PowerPoint presentation, and the user modifications may comprise a pointer to specific portions of a particular slide inserted by a user to enhance comprehension of the presentation. It will be appreciated that by including such user modifications in the first and second screen shots, there is provided the potential to interactively refer to specific portions of a screen shot for example in a telephone call to a meeting participant thereby to reduce the risk of confusion. In addition to pointers, user modifications may include additions and deletions to a screen shot.

In one embodiment, the computer K receives input of a user-defined screen area, which forms a definition for the first and second screen shots. This feature provides the ability to select only portions of data presented in a screen of the active application.

In one embodiment, the computer K also automatically generates code to cause the web page to be automatically downloaded from the directory at periodic intervals. Thus, a browser of a computer that is used to view the web page will automatically “pull” the web page from the computer K, at periodic intervals. In one embodiment, the periodic intervals may be user defined.

In one embodiment, the file (hereinafter the “original file”) that is being viewed using the active application is also copied to the directory. In one embodiment, the computer K generates a hypertext link to the original file in the directory, and embeds the hypertext link to the original file in the web page.

In one embodiment, updating the code to create the web page to reference the second screen shot comprises replacing the reference to the first screen shot with the reference to second screen shot.

In one embodiment, multiple screen shots may be saved in the directory, each of the multiple screen shots being at a different scale or magnification. In this case, the code to generate the web page may include references to each screen shot at a difference scale. This embodiment is illustrated in FIG. 15 of the drawings, where it will be seen that user A saves and uploads multiple copies of a screen shot “S” at varying scales to a remote server “T.” Thereafter users B, C, and D are able to view the web page in a selected scale.

Referring to FIG. 16 of the drawings, reference numeral 1600 generally indicates hardware that may be used to implement the above-described system. The hardware 1600 typically includes at least one processor 1602 coupled to a memory 1604. The processor 1602 may represent one or more processors (e.g., microprocessors), and the memory 1604 may represent random access memory (RAM) devices comprising a main storage of the hardware 1600, as well as any supplemental levels of memory e.g., cache memories, non-volatile or back-up memories (e.g. programmable or flash memories), read-only memories, etc. In addition, the memory 1604 may be considered to include memory storage physically located elsewhere in the hardware 1600, e.g. any cache memory in the processor 1602, as well as any storage capacity used as a virtual memory, e.g., as stored on a mass storage device 1610.

The hardware 1600 also typically receives a number of inputs and outputs for communicating information externally. For interface with a user or operator, the hardware 1610 may include one or more user input devices 1606 (e.g., a keyboard, a mouse, etc.) and a display 1608 (e.g., a Cathode Ray Tube (CRT) monitor, a Liquid Crystal Display (LCD) panel).

For additional storage, the hardware 1600 may also include one or more mass storage devices 1610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 1600 may include an interface with one or more networks 1612(e.g., a local area network (LAN), a wide area network (WAN), a wireless network, and/or the Internet among others) to permit the communication of information with other computers coupled to the networks. It should be appreciated that the hardware 1600 typically includes suitable analog and/or digital interfaces between the processor 1602 and each of the components 1604, 1606, 1608 and 1612 as is well known in the art.

The hardware 1600 operates under the control of an operating system 1614, and executes various computer software applications 1616, components, programs, objects, modules, etc. (e.g. a program or module which performs operations described above. Moreover, various applications, components, programs, objects, etc. may also execute on one or more processors in another computer coupled to the hardware 1600 via a network 1602, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

It will be appreciated by persons skilled in the art that the present invention is not limited by what has been particularly shown and described hereinabove. Rather the scope of the present invention is defined only by the claims as follows.

1. A method, comprising:
automatically capturing a first screen shot of an active application;
saving the first screen shot in a directory from which a server attempts to retrieve downloadable files for a network;
automatically generating a code to create a web page, wherein the code contains a reference to the first screen shot; and
publishing the web page.

2. The method of claim 1, further comprising a) automatically capturing a second screen shot of the active application at a later time; b) saving the second screen shot in the directory; and c) updating the code to create the web page to contain a reference to the second screen shot.

3. The method of claim 2, wherein a), b), and c) are repeated periodically.

4. The method of claim 2, wherein saving the second screen shot comprises overwriting the first screen shot.

5. The method of claim 1, wherein the first and second screen shots comprise screen shots of a file being viewed using the active application.

6. The method of claim 4, further comprising saving an original of the file being viewed in the directory.

7. The method of claim 1, wherein the directory is a default directory.

8. The method of claim 7, wherein the default directory is the wwwroot directory.

9. The method of claim 4, wherein the file comprises a file stored in a database.

10. The method of claim 1, wherein publishing the web page comprises sending an instant message containing a link to the web page to another computer.

11. The method of claim 2, wherein the first and second screen shots are screen shots of a streaming media file.

12. The method of claim 2, wherein the first and second screen shots comprise user modifications to the file being viewed using the active application.

13. The method of claim 1, further comprising receiving input of a user-defined screen area defining the first, and the second screen shots.

14. The method of claim 1, wherein the directory is a local directory.

15. The method of claim 1, wherein the directory is a remote directory.

16. The method of claim 6, further comprising generating a hypertext link to the original file; and embedding the hypertext link to the original file in the web page.

17. The method of claim 1, further comprising generating code to cause the web page to be automatically downloaded from the directory at periodic intervals.

18. The method of claim 17, wherein the periodic intervals are user-defined.

19. The method of claim 2, wherein updating the code to create the web page to reference the second screen shot comprises replacing the reference to the first screen shot with the reference to the second screen shot.

20. The method of claim 1, wherein saving the first screen shot comprises saving one or more copies of the first screen shot, each at a different scale.

21. The method of claim 20, wherein automatically generating the code to create the web page comprises generating references to the one or more copies of the first screen shot.

22. The method of claim 1, wherein the first and second screen shots comprise original data and presentation information to control the presentation of the original data.
